(19) United States
(12) Patent Application Publication
(10) Pub. No.: US 2003/0059005 A1
(43) Pub. Date: Mar. 27, 2003

(54) Multi-media communication management system with dynamic bypass routing of real time streaming media

(75) Inventors: Robert F. Meyerson, Naples, FL (US); Calvin E. Lewis, Copley, OH (US)

Correspondence Address: TIMOTHY P. O'HAGAN, 8710 KILKENNY CT, FORT MYERS, FL, 33912, US

(73) Assignee: Teleware, Inc., Akron, OH

(21) Appl. No.: 10/147,733

(22) Filed: May 16, 2002

Related U.S. Application Data
(63) Continuation-in-part of application No. 10/000,543, filed on Oct. 23, 2001.
Application No. 10/000,543 is a continuation-in-part of application No. 09/961,532, filed on Sep. 24, 2001.

(51) Int. Cl. H04M 1/64; H04M 7/00

(52) U.S. Cl. 379/88.17; 379/219

(57) ABSTRACT

A communication system controller interconnects a plurality of communication stations with each of the Internet and the public switched telephone network. Each communication station may communicate both real time streaming media frames and non-real time data frames on the Internet. The system controller includes a local area network interface for receiving frames, including both real time streaming media frames and non-real time data frames, from a communication station and a frame buffer for queuing the frames for transmission on the Internet. The system controller also provides for establishing a supplemental PSTN channel to a remote endpoint over the PSTN when the frame buffer has filled above a predetermined capacity. A routing circuit routes at least a portion of the real time streaming media frames to the remote endpoint on the supplemental PSTN channel.

### CROSS-REFERENCE TO RELATED ACTIONS

This application claims the benefit of, and is a continuation in part of U.S. patent application Ser. No. 10/000,543 filed on Oct. 23, 2001, entitled “Modular Multi-Media Communication Management System,” that is a continuation in part of U.S. patent application Ser. No. 09/961,532 entitled “Teledata Space and Docking Station with Modular and Integrated Display” filed on Sep. 24, 2001, the contents of both such patent applications being incorporated herein.

### FIELD OF THE INVENTION

The invention relates generally to managing multi-media communications, and more particularly to a multi-media communication management system with dynamic session routing modification.

### BACKGROUND OF THE INVENTION

In an office environment, desk top telephone service is typically provided by a private telephone system. Early key switch systems include a control unit that is coupled to each desk top telephone utilizing a conventional plain old telephone service (POTS) analog subscriber loop. The control unit enables calls between the various desk top telephones and, upon activation of an applicable key on the desk top telephone, couples the desk top telephone to one of the public switched telephone service (PSTN) analog lines. This enables the user of a desk top phone to both answer a ringing outside line and to place outgoing calls on the PSTN. The quantity of PSTN lines (e.g analog trunk lines) coupled to the control unit limits the number of calls between desk top telephones and the PSTN that can be simultaneously in session.

More recent private telephone systems include a control unit that is coupled to each desk top telephone utilizing a digital subscriber loop and is coupled to the PSTN central office controller utilizing a digital trunk interface such as a Primary Rate Interface (PRI). One advantage of a PRI interface is that a separate pair of wires is not required for each call that may be simultaneously in session. For example, a 4-wire PRI interface can support 23 “B” channels (e.g. one channel for each voice session) and one 64K “D” channel for setting up and tearing down telephone calls on each of the “B” channels. Another advantage of a PRI interface is that is supports direct dial and both inbound and outbound caller ID information.

When a call is placed to a direct dial telephone number associated with a desk top telephone, the PSTN routes the call to the central office supporting the private telephone system. A DID identifier is then provided by the central office system to the private telephone system control unit on the “D” channel to identify the particular desk top telephone to which the call is being placed. As such, the control unit can ring the desk top telephone without having to route through an operator or an auto attendant whereby the caller identifies an extension.

Further, when an inbound call is place to a direct dial telephone number, the central office supporting the private telephone system may further send caller ID information to the control unit on the “D” channel. The control unit can provide this to the desk top telephone in association with ringing the desk top telephone. When an outbound call is placed from a desk top telephone, the control unit will utilize the “D” channel to set up the call to the central office and may even provide caller ID information identifying the desk top telephone to the central office for forwarding to the callee over the PSTN.

More recently yet, Internet based telephone systems have been developed. Rather than coupling to the PSTN, a control unit may couple to the Internet whereby it can place and receive calls through a gateway server utilizing predefined voice over IP protocols such as the Session Initiation Protocol (SIP) promulgated by the Internet Engineering Task Force (IETF) for setting up and tearing down a VOIP telephone call and Real time Transport Protocols (RTP) over UDP/IP channels for exchanging compressed digital audio data.

The advantage of an Internet based telephone system is that the number of simultaneous call sessions is limited only by the bandwidth of the system's connection to an Internet Service Provider. As such, communication rates may be less expensive. Further, SIP messaging can support caller ID and can support other call management features that may not be supported over a PRI interface.

I primary disadvantage of an Internet based system is that there is that the nature of frame based routing from a source to a destination on the Internet does not assure that all frames representing digital compressed voice will reach the destination or that frames will reach the destination within a time frame wherein the frames can be used. Such can result in portions of words being clipped and/or the conversation stream being delayed.

What is needed is a multi-media communication management system that includes the benefits of an Internet based system but does not suffer the disadvantages of such known systems.

### SUMMARY OF THE INVENTION

The multi-media communication management system comprises a controller that interfaces with a plurality of subscriber stations, and their associated subscriber device(s), and with one or more communication medium service providers.

The controller translates multi-media communications received from a multi-media service provider into the protocols required for use by the subscriber stations. More specifically, the controller includes a local area network interface for receiving frames, including both real time streaming media frames and non-real time data frames, from a communication station and a frame buffer for queuing the frames for transmission on the Internet. The system controller also provides for establishing a supplemental PSTN channel to a remote endpoint over the PSTN when the frame buffer has filled above a predetermined capacity. A routing circuit routes at least a portion of the real time streaming media frames to the remote endpoint on the supplemental PSTN channel.

The communication and control signaling between the controller and the subscriber stations may be wireless in nature with the subscriber stations each powered by an internal battery and/or connection to a local source of conventional line power.

The architecture of the subscriber station is modular. Multiple functional elements can be interconnected with backbone communication circuitry to form an integrated communication platform. Modular docking interfaces may be used to couple the subscriber station to a portable subscriber device and to enable integrated and coordinated communication through multiple communication medium service providers.

These and other advantages of the invention, along with the invention itself, will be more fully understood after a review of the following figures, detailed description, and claims.

### BRIEF DESCRIPTION OF THE FIGURES

FIG. 1 is a block diagram representing an overview of operation of the present invention;

FIG. 2, is a block diagram view of a modular multi-media communication management system in accordance with one embodiment of the present invention;

FIG. 3 is a block diagram of a multi-media communication management system controller in accordance with one embodiment of the present invention;

FIG. 4 is a perspective exploded view of a modular communication subscriber station in accordance with one embodiment of the present invention;

FIG. 5 is a block diagram of a subscriber station in accordance with one embodiment of the present invention;

FIG. 6 is a block diagram of a subscriber data assistant in accordance with one embodiment of the present invention;

FIG. 7 is a block diagram of a wide area network communication device in accordance with one embodiment of the present invention;

FIG. 8a is a table diagram representing a current network location table in accordance with one embodiment of the present invention;

FIG. 8b is a table diagram representing a multicast group table in accordance with one embodiment of the present invention;

FIGS. 9a through 9j each show a flow chart representing processing steps performed by a multi-media communication management system in accordance with one embodiment of the present invention;

FIGS. 10a through 10f each show an exemplary display of information to a subscriber utilizing a subscriber interface of a subscriber station in accordance with one embodiment of the present invention;

FIGS. 11a through 11c each show a flow chart representing exemplary operation of packet audio/video gateway in accordance with one embodiment of the present invention; and

FIG. 12 is a block diagram of a real time frame router circuit in accordance with one embodiment of the present invention;

### DETAILED DESCRIPTION OF PREFERRED EMBODIMENTS

The present invention is now described in detail with reference to the drawings. In the drawings, each element with a reference number is similar to other elements with the same reference number independent of any letter designation following the reference number.

It should also be appreciated that many of the elements discussed in this specification may be implemented in hardware circuit(s), a processor executing software code, or a combination of a hardware circuit and a processor executing code. As such, the term circuit or module as used throughout this specification is intended to encompass a hardware circuit (whether discrete elements or an integrated circuit block), a processor executing code, or a combination of a hardware circuit and a processor executing code, or other combinations of the above known to those skilled in the art.

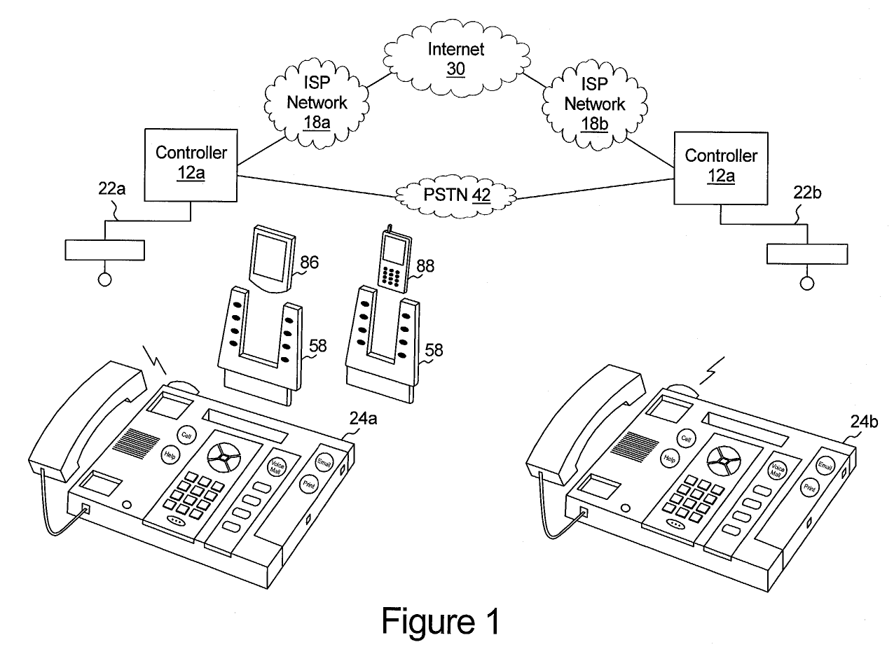

The block diagram of FIG. 1 represents an overview of the present invention. The present invention facilitates real time streaming media audio communications between a first subscriber station 24a served by a first multi-media communication management control unit 12a and a second subscriber station 24b served by a second multi-media communication management control unit 12b.

The first subscriber station 24a communicates with the first control unit 12a utilizing wireless local area network 22a. Similarly the second subscriber station 24b communicates with the second control unit 12b utilizing a wireless local area network 22b. Both wireless local area network 22a and 22b may be Internet protocol compliant networks such that each subscriber station 24a and 24b may establish, maintain, and tear down voice-over IP (VOIP) telephony sessions. The VOIP sessions may utilize protocols such as the Session Initiation Protocol (SIP) promulgated by the Internet Engineering Task Force (IETF) for signaling, establishing, and tearing down a VOIP telephone call and Real time Transport Protocols (RTP) over UDP/IP channels for exchanging compressed digital audio data to maintain the session.

Each controller 12a and 12b is coupled to the Internet 30 through a multi-media service provider communication network (e.g. Internet Service Provider network or ISP network) 18a and 18b respectively. As such, UDP/IP channels may be used to transport RTP frames between subscriber station 24a and subscriber station 24b during a communication session over the Internet 30 to effect a telephone conversation between users of the two devices.

During the course of the session, at least one of controllers 12a and 12b may monitor the quality of service to measure whether quality of service failure has occurred. A quality of service failure may include at least one of frame delay or frame loss exceeding predetermined thresholds whereby audio quality, as noticed by a user, would be degraded. Upon the occurrence of a quality of service failure, a supplementary connection utilizing the PSTN 42 between controller 12a and controller 12b may be established and frames (both RTP frames and SIP control frames) may be routed over such supplementary connection to reduce frame delay and loss.

Further, in the event that a controllers 12a, 12b connection to its ISP network 18a, 18b becomes congested (e.g. its frame buffer for transmission on the ISP network 18a or 18b begins to fill beyond a predetermined capacity), the controller 12a or 12b may establish a supplementary connection to another controller to which a stream of RTP frames is being sent and route the RTP stream over the supplementary connection to relieve congestion on the connection to the ISP network 18a, 18b. This may occur even if a quality of service failure has not occurred for that particular RTP stream. For example, if the controller 12a supports several computing devices on network 22a, each of which is attempting to access data from a remote server on the Internet 30, a quality of service failure on an RTP stream representing an audio conversation may not occur because such frames may have priority in the frame buffer of the control unit 12a. However, data frames to or from the computer devices may be overflowing the buffer or significantly delayed in the buffer prior to transmission. In such a case, it would be advantageous for control unit 12a to establish a supplementary connection to the control unit to which the RTP frames are being sent to eliminate routing such frames to the ISP network 18a.

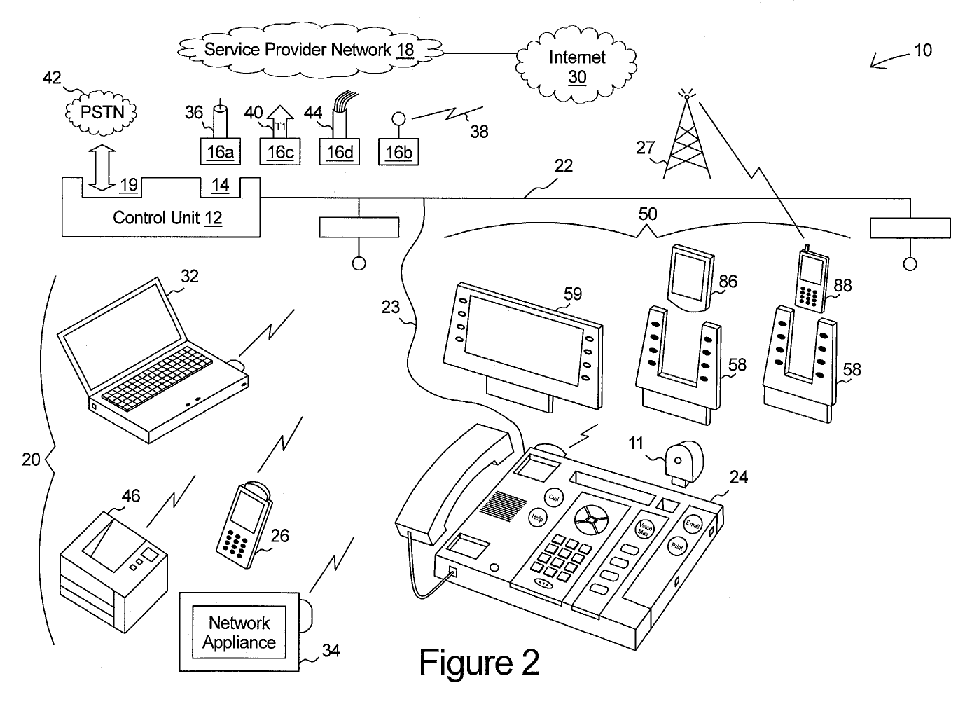

Referring to FIG. 2, an exemplary architecture of a multi-media communication management system 10 is shown. The multi-media communication management system 10 includes its control unit 12 that is coupled with a plurality of local communication devices 20 over a wireless local area network 22 (or by a wired network connection 23 to the backbone wired network of the wireless local area network 22).

The local communication devices 20 may include: subscriber stations 24, wireless dialog handsets 26, traditional computer systems 32, network printers 46, and various network appliances 34.

The control unit 12 includes a circuit-switched provider bay 19 which operatively couples the control unit 12 to the public switched telephone network (PSTN) 42 and includes an ISP service provider bay 14 which operatively couples the control unit 12 to the ISP network 18 through one of a plurality of communication medium modules 16a-16d.

In the exemplary embodiment, the ISP network 18 may utilize the Internet Protocol Suite for communication at the IP level, but may be proprietary at the data link and physical layers. As such, the control unit 12 includes the IP stacks applicable for communication between applications over the network 18 and each module 16a-16d includes the applicable data link and physical layer circuits for communication of IP frames over the physical medium of the network 18.

Some illustrative examples of communication modules include: communication module 16a which may be a cable modem module for communicating over coaxial cable 36 with an ISP such as a local cable company, communication module 16b which may be a wide area network radio for communication over a wireless spectrum channel 38 with a wide area wireless ISP such as an analog or digital cellular/PCS telephone service provider, communication module 16c which may be a customer service unit (CSU) for communication over a T1 line 40 with an ISP such as a local telephone service provider, and communication module 16d which may be an optical modem for communication over a fiber channel 44 with a fiber optic ISP network.

In operation, the control unit 12 integrates and manages multi-media communication between two or more local communication devices 20 and between each local communication device 20 and a remote communication system(s) (not shown) coupled to either the ISP network 18 or the PSTN 42.

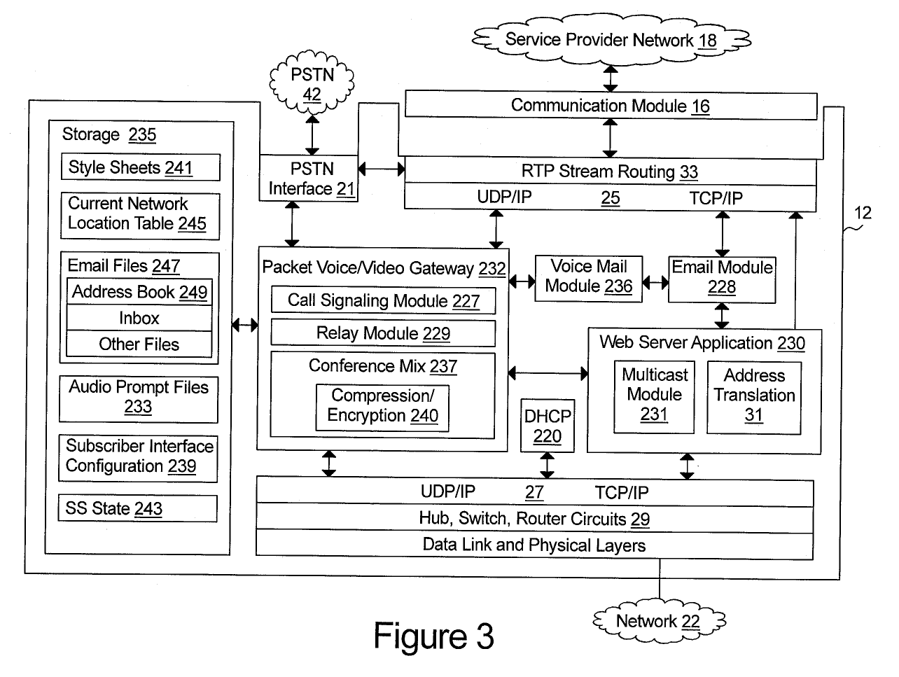

FIG. 3 shows a block diagram of an exemplary control unit 12. The control unit 12 includes applicable modules for managing the local area network 22 as an IP network. Such modules may include an applicable combination of hubs, routers, and switches 29 for managing communications over the network 22 as well as an address server 220 (e.g. DHCP server) for assigning local IP addresses to each local communication device 20.

The control unit 12 may also include a packet audio/video gateway 232, a voice mail module 236, an email module 228, and a web server application 230.

Packet Voice Gateway

The packet audio/video gateway 232 provides a subscriber's real time full duplex audio and/or video call and conference call services. The services may include routing and maintaining a subscriber's outgoing calls, a subscriber's incoming calls, and a subscriber's conference calls.

A subscriber's outgoing calls are calls initiated by the subscriber utilizing a subscriber station 24. A subscriber's incoming calls are calls initiated by a remote caller to the subscriber. Each call takes place over a real time communication session between the subscriber station 24 serving the subscriber and a remote device serving the other call participant. The remote device may be another subscriber station 24, a VOIP device coupled to the Internet 30 (or to a VOIP proxy coupled to the Internet 30), or a PSTN device coupled to the PSTN 42.

A real time communication session between the subscriber station 24 and another subscriber station 24, or a VOIP device coupled to the Internet 30, will be a VOIP session with the subscriber station 24 being one endpoint of the VOIP session and the other subscriber station 24, or the VOIP device, being the other endpoint.

A real time communication session between a subscriber station 24 and a PSTN device coupled to the PSTN 42 comprises a VOIP session between the subscriber station 24 and the gateway 232 plus a PSTN session between the gateway 232 and the PSTN device. In this case, the subscriber station 24 and the gateway 232 are the two endpoints of the VOIP session and the gateway 232 and the PSTN device are the two PSTN endpoints of the PSTN session.

Establishing and managing a VOIP session between two endpoints includes exchanging session signaling messages, channel negotiation messages, compression capability messages, and optionally encryption capability and key messages between the two endpoints utilizing predetermined message protocols such as the SIP protocols. The messages are exchanged utilizing UDP/IP datagrams transferred between the two endpoints over the network 22, the ISP network 18, and the Internet 30. The gateway 232 operates as an address directory for locating an endpoint on the local area network 22 and as an IP layer proxy for exchanging datagrams between the two endpoints if one of the two endpoints is coupled to the Internet 30.

After a VOIP session is established, communication of audio (and video) data between the two endpoints comprises compressing digital audio data into a sequence of RTP frames, optionally encrypting the RTP frames, and sending the RTP frames to the other endpoint utilizing UDP/IP datagrams on the negotiated channels. At the other endpoint, the UDP/IP datagrams are received, sequenced, and the RTP frames are recovered, decrypted (if applicable), and decompressed to yield the digital audio data.

Establishing a PSTN session between two PSTN endpoints includes use of standard PSTN analog or PSTN digital signaling and, after the PSTN session is established, communication of audio data between the two PSTN endpoints comprises standard PSTN analog or PSTN digital communications.

A multi-party conference call initiated by the subscriber to a plurality of callee participants comprises a VOIP session between the initiating subscriber's subscriber station 24 and the gateway 232 plus a plurality of participant sessions. These participant sessions are VOIP sessions and/or PSTN sessions, each between the gateway 232 and a participating subscriber station 24, a participating VOIP device coupled to the Internet 30, or a participating PSTN device coupled to the PSTN 42.

To support the above described functionality, the gateway 232 comprises a PSTN interface module 19, a call signaling module 227, a relay module 229, a conference mix module 237, and a compression/encryption module 240.

The PSTN interface module 21 includes circuits for translating between PSTN session signaling (and analog or PSTN digital audio communication) and digital session signaling messages (and digital audio communication formats and protocols) for use by the other elements of the packet audio/video gateway 232.

The call signaling module 227 includes a routing circuit, a session signaling circuit, and a directory circuit that work in combination to provide: i) routing of a subscriber's incoming calls to his or her then current subscriber station 24; ii) routing the subscriber's outgoing calls to a destination subscriber station 24, a destination VOIP device on the Internet 30, or to a destination PSTN subscriber loop; and iii) establishing calls between the gateway 232 and each conference participant.

The routing circuit provides for routing session signaling messages between the two VOIP endpoints when the gateway 232 itself is not one of the endpoints. The session signaling circuit generates session signaling messages and establishes a VOIP session on behalf of the gateway 232 if the gateway 232 is an endpoint of the VOIP session being established (e.g. a session between a subscriber station 24 and a PSTN device or a conference call including the subscriber station 24). Both the routing circuit and the session signaling circuit operate under control of the directory circuit.

With respect to a subscriber's outbound calls (and with respect to a subscriber's conference calls), the directory receives session signaling messages from the subscriber's subscriber station 24 (or from the conference mix module 237 if a conference call) that includes a number identifying the callee and routes (or redirects) the call to a callee device. The number identifying the callee may be a 10 digit number representing a subscriber loop of the PSTN 42, a number identifying a person associated with a VOIP device coupled to the Internet 30, or a subscriber ID representing a subscriber to the system 10.

If the number represents a VOIP device coupled to the Internet 30, the number may be an ID number permanently assigned to the callee. However, the IP network address utilized by the callee device may change periodically. As such, the directory circuit may query a remote directory server to determine the network address of the device (or the network address of a proxy for the device) and provide the network address to the subscriber station 24 as a redirect address such that the subscriber station 24 may initiate session signaling directly to the callee device or the proxy.

If the number represents a subscriber loop of the PSTN 42, the directory circuit provides the number to the PSTN interface 21, such that the PSTN interface circuit may establish a PSTN session with a PSTN device coupled to the subscriber loop. The directory circuit also instructs the call signaling module 227 to respond to the call signaling to establish a VOIP session between the subscriber station 24 and the gateway 232. If the number represents a subscriber to the system 10, steps discussed below with respect to receiving an inbound call for a subscriber are applicable.

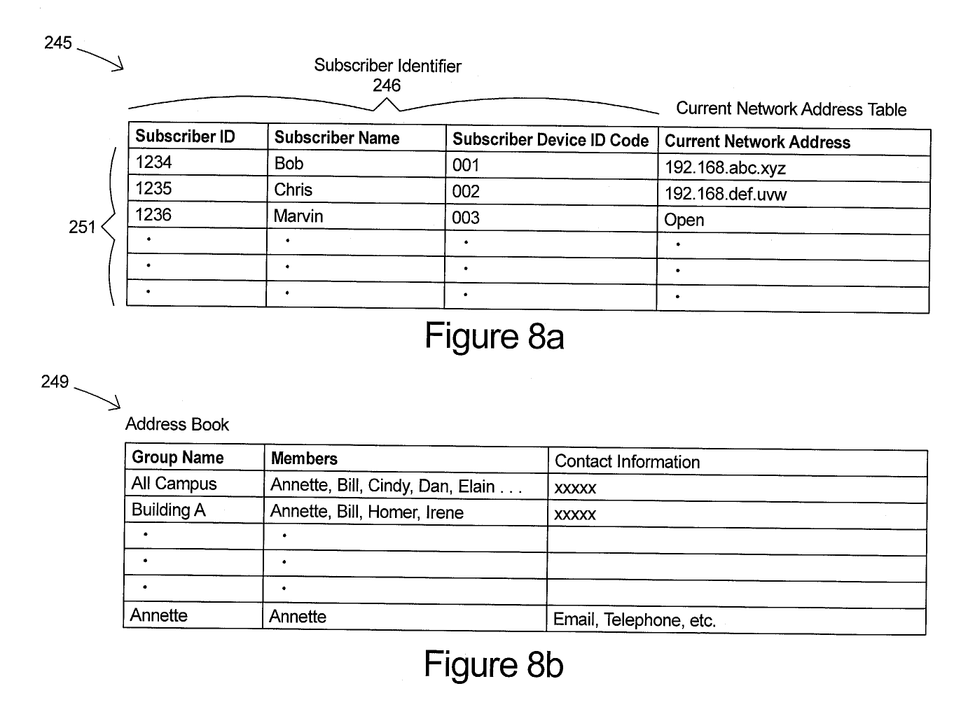

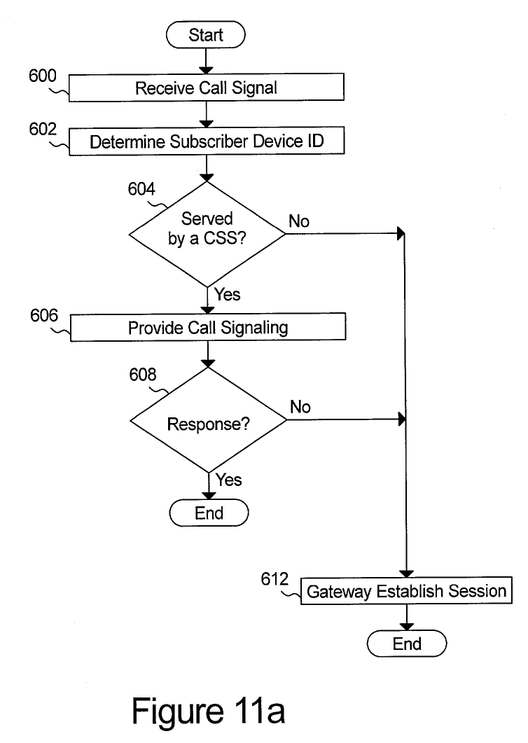

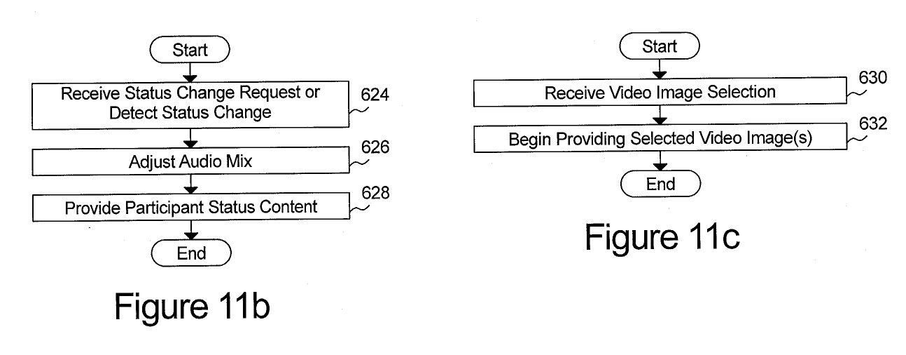

With respect to a subscriber's inbound calls, the directory circuit receives session signaling messages from a caller device that identifies a subscriber as the callee, and routes the call to the particular subscriber station 24 that is then servicing the subscriber or, if the subscriber is not served by a subscriber station 24 or is already participating in a call, routes the call to the voice mail module 236 such that the caller may leave a message for the subscriber. Referring to FIG. 11a in conjunction with the current network location table 245 of FIG. 8a, the process of identifying the subscriber station 24 servicing the subscriber is shown.

Step 600 represents receipt of the session signaling message identifying the subscriber. In the exemplary embodiment, each subscriber may be assigned a subscriber identifier number that corresponds to the last digits of a PSTN direct dial number that routes to the control unit 12 when dialed on the PSTN. As such, the session signaling message, whether originated by a VOIP device coupled to the Internet 30, a subscriber station 24 coupled to the network 22, or the PSTN interface 21 (in response to PSTN session signaling over the PSTN 42), may include the subscriber identifier number to identify the destination subscriber.

At step 602, the directory circuit identifies a subscriber device 50 (FIG. 2) that is associated with the identified subscriber utilizing the network location table 245. To associate each subscriber with his or her subscriber device 50, the network location table 245 includes a record 251 for each subscriber. Within such record are fields that identify the subscriber, identify the subscriber identifier number associated with the subscriber, and identify a subscriber device ID code that is unique to the subscriber device 50 that is assigned to the subscriber.

At step 604 the directory circuit identifies whether the subscriber's subscriber device 50 is served by a subscriber station 24. The network location table 245 further includes a field that may comprise the network address of the subscriber station 24 that is then currently serving the subscriber device 50 assigned to the subscriber. The address within this field will be updated when the subscriber moves his or her subscriber device 50 from one subscriber station 24 to another using circuits and methods discussed herein. If the subscriber device 50 is not currently served by any subscriber station 24, then the field will indicate such as represented by the term “open”.

If at step 604, the directory circuit determines that the subscriber device 50 assigned to the subscriber is not currently served by any subscriber station 24, the directory circuit instructs the call signaling module 227 to establish the session on behalf of the gateway 232 such that the caller will be coupled to the voice mail module 236 at step 612.

If the subscriber device is served by a subscriber station 24, however, the directory circuit at step 606 either: i) provides the network address of the subscriber station 24 (as a redirect address) to the caller device if the caller device is coupled to the local area network 22; ii) instructs the routing circuit to send the call signaling messages to the subscriber station 24 if the caller device is a VOIP device coupled to the Internet 30; or iii) instructs the session signaling circuit to respond to the session signaling and establish a VOIP session with the subscriber station 24 if the caller device is coupled to the PSTN 42.

Step 608 represents the directory circuit determining whether the response of the subscriber station 24 is such that a communication session can be established with the subscriber station 24. In certain events, such as when the subscriber is already engaged in a call or if the subscriber does not answer the inbound call, the directory circuit will determine that a session can not be established with the subscriber station 24 (either immediately or after a brief time period of the subscriber station 24 ringing but remaining unanswered). In this case, the directory circuit instructs the call signaling module 227 to establish the session on behalf of the gateway 232 such that the caller will be coupled to the voice mail module 236 at step 612.

The relay module 229 includes circuits for operating as an IP layer proxy for VOIP sessions between a subscriber station 24 endpoint and a VOIP device coupled to the Internet 30.

The compression/encryption module 240 performs the translation between digital audio data and compressed/encrypted RTP frames for VOIP sessions for which the gateway 232 is itself an endpoint (e.g. sessions between a subscriber station 24 and a PSTN device and sessions between the gateway 232 and each conference participant).

The conference mix module 237 includes an audio mixing circuit, a video routing circuit, and a conference session control circuit. The audio mixing circuit receives audio streams from each participating endpoint in the form of digital audio data provided by the compression/encryption module 240 or the PSTN interface 21 and generates digital audio data comprising one or more conference mix audio streams. The conference mix module 237 provides applicable conference mix audio streams back to each participating endpoint. It is undesirable to include the voice of a participant in the conference mix audio stream that will be returned back to such participant's endpoint because echoes could occur. As such, a single conference call may require multiple conference mix audio streams—one for each participant that excludes such participant's own voice.

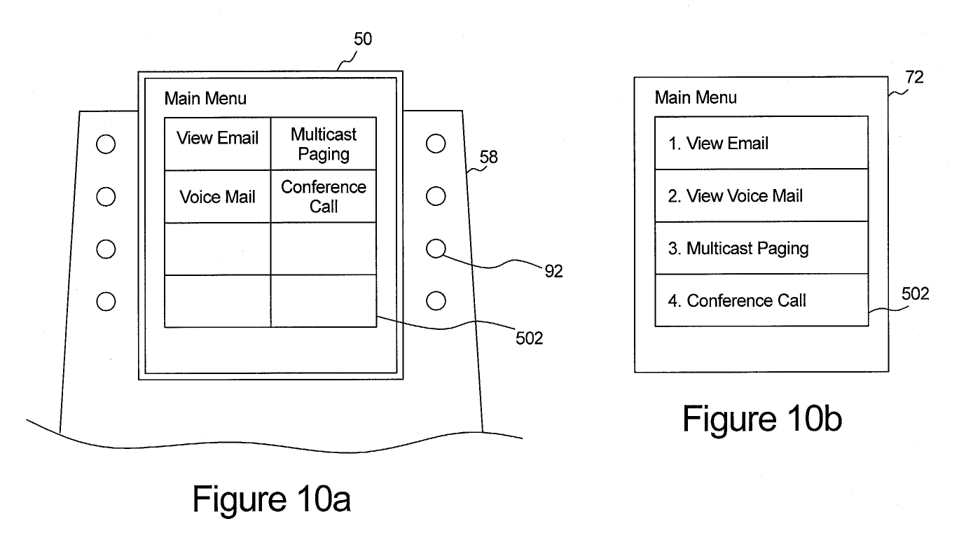

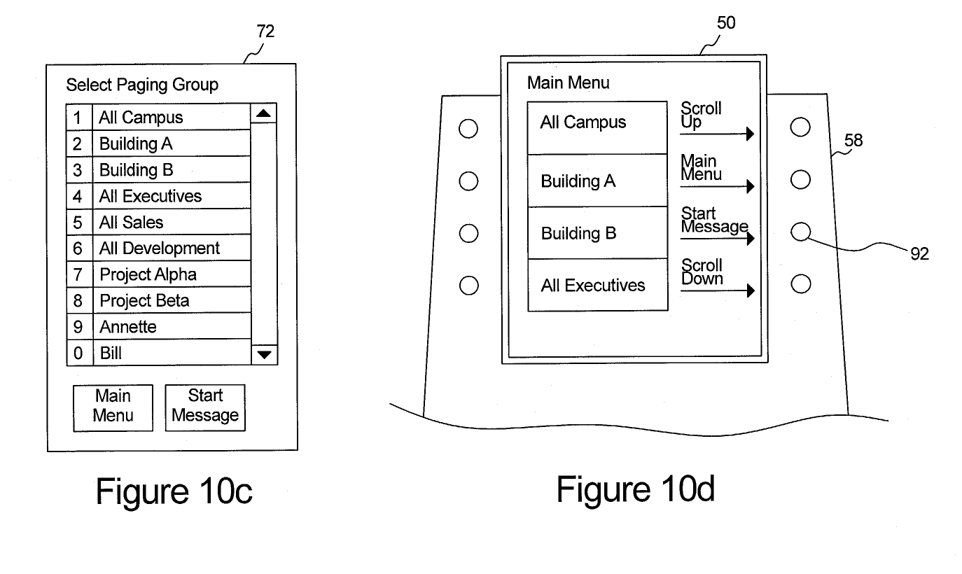

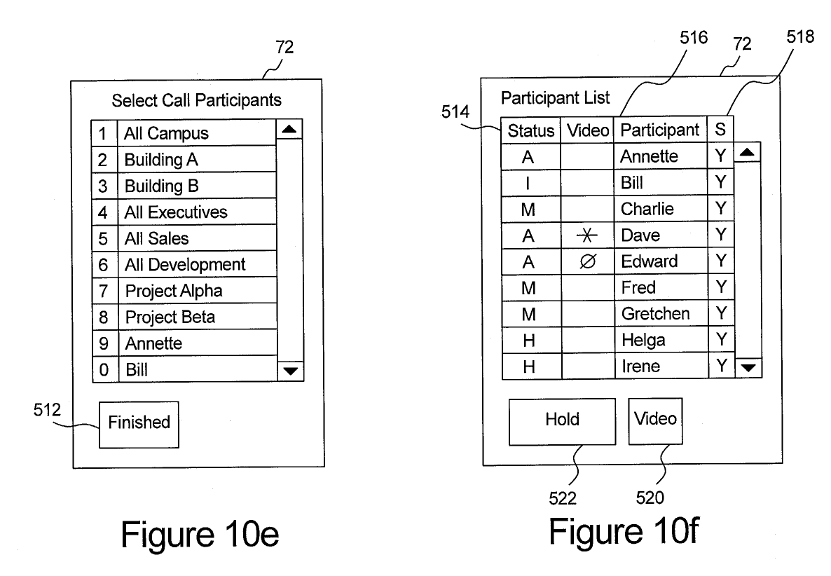

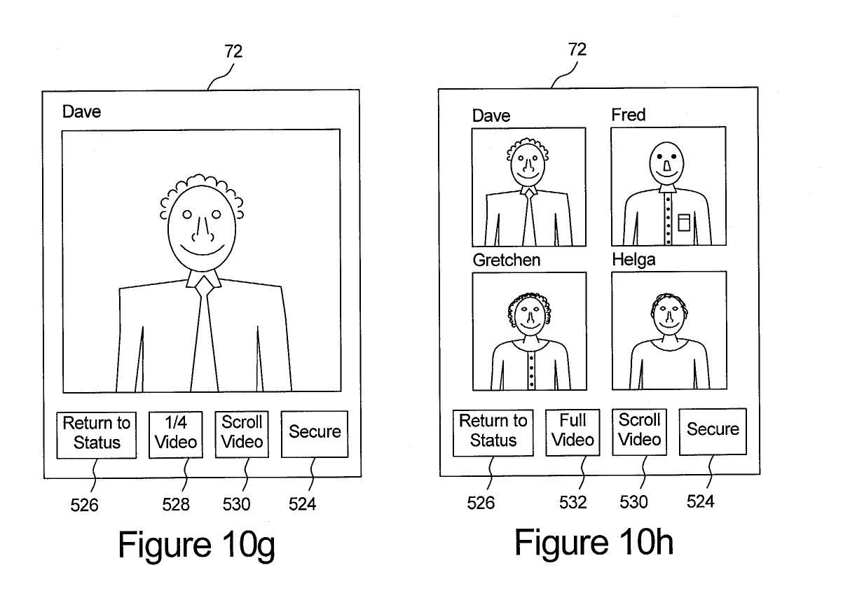

The video routing circuit receives a video stream from each participating endpoint that has video capture capabilities in the form of digital video data provided by the compression/encryption module 240. The video routing circuit also provides selected video streams back to each participating endpoint in accordance with instructions from the web server 230 discussed with respect to FIGS. 10e-10h.

The conference session control circuit receives conference set up signaling messages from an initiating subscriber station 24 that includes a number identifying each conference participant. The conference session control circuit provides session signaling messages to the call signaling module, each including a number identifying a conference participant, such that the call signaling module may establish a communication session between the gateway 232 and each participant.

At any time during a conference session, the conference session control circuit may receive a message from a participating endpoint instructing the conference mix module 237 to secure the conference session. In response to such message, the conference session control circuit will instruct the call signaling module 227 to generate applicable messages to begin (or continue, or at least not stop) encrypting each VOIP session comprising the conference session and to report which, if any, VOIP sessions have successfully begun encryption (or continue to be encrypted).

After receiving a report of successful encryption, the control circuit will provide signals to the web server 230 so that the web server 230 may: a) update applicable displays associated with each participating subscriber station 24 as discussed with respect to FIGS. 10e-10h; and, b) if all VOIP sessions are secure, send a message to each participating subscriber station 24 to provide for the secure button 108 to illuminate.

Voice Mail Module

The voice mail module 236 includes circuits for providing a sequence of RTP frames representing applicable audio prompts from compressed audio prompt files 233 to the compression/encryption module 240, receiving RTP frames from the compression/encryption module 240 representing the voice of the remote caller leaving a message for the subscriber, compressing the message into a digital audio file, and sending the digital audio file to the email module 228 for storage in the email files 247 for later retrieval by the subscriber.

Email Module

The email module 228 maintains an email account associated with each subscriber. The email module 228 includes client circuits for interfacing with a remote email server. The email module 228 logs onto an account associated with each subscriber, obtains new email messages associated with the subscriber, and sends email messages drafted by the subscriber to the remote server. The email module 228 also maintains email files 247 in the storage 235 that may include an address book and an inbox for each subscriber.

WebServer

The web server application 230 provides additional multi media communication services provided to each subscriber. Examples of the multi media communication services provided to each subscriber by the web server application 230 include: a) delivery of email and voice mail messages (as emailed audio files) to the subscriber station 24 at which the subscriber's subscriber device 50 is then currently coupled; b) updating of the network location table 245 to assure proper routing of incoming audio and audio/video calls; c) proxy communication over network 18; d) delivery of multicast messages directed to a subscriber of the particular subscriber station 24 at which his or her subscriber device is then currently coupled; and e) providing subscriber control of audio and audio/video conference calls through the packet voice gateway 232.

The web server application 230 includes a multicast module 231 and an address translation module 31. The multicast module 231 provides IP multicast services to enable the web server application 230 to deliver select communications to multiple subscriber stations 24 simultaneously utilizing IP multicast protocols and without using excessive bandwidth on network 22. The address translation module 31 provides address and port translation services to enable the web server 230 to provide each subscriber station 24 with access to servers coupled to the network 18 as an IP layer proxy and without using higher layer resources of the control unit 12.

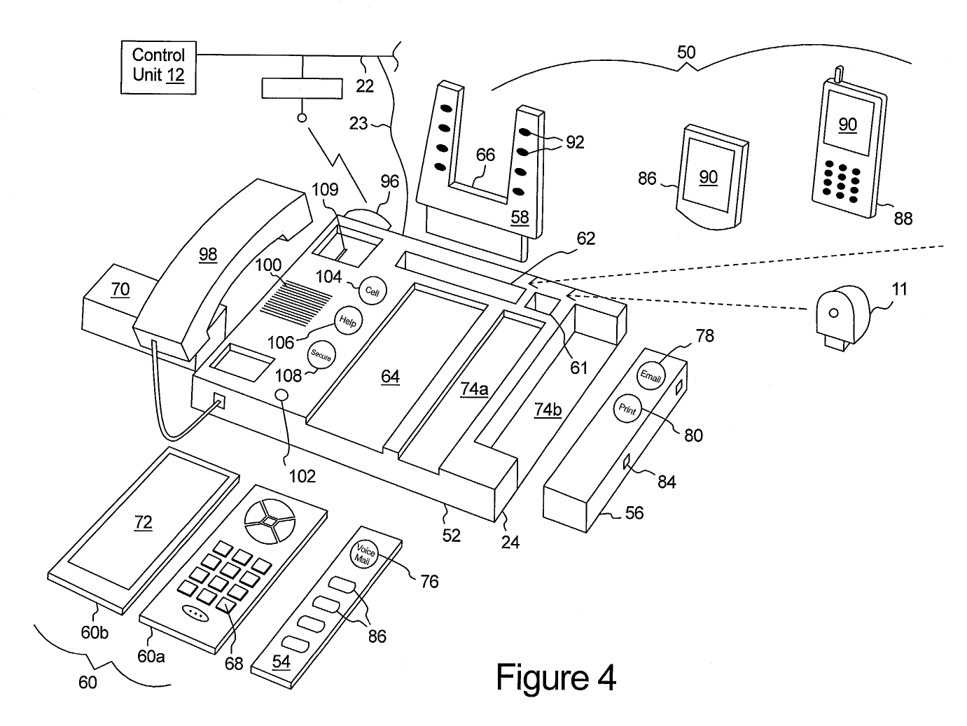

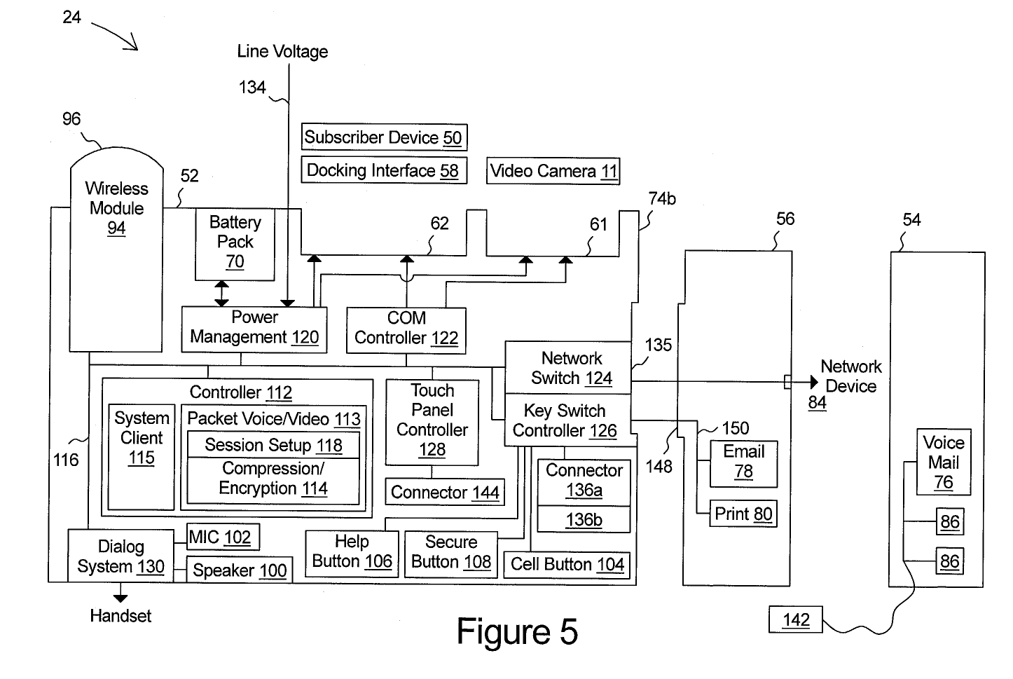

In the exemplary embodiment, non streaming media communication between the web server application 230 and each subscriber station 24 utilizes tagged data messages over a TCP/IP session between the web server application 230 and a system client application 115 (FIG. 5) within the subscriber station 24. Each message transferred between the web server application 230 and the subscriber station 24 comprises a data element and a tag identifying the significance of the data element. For example: a) if the data element comprises the text of an email message, the tag would identify the data element as the text of an e-mail message; b) if the data element comprises an executable script that would provide for the subscriber station 24 to perform a certain function, the tag would identify the data element as executable script and may identify the significance of the script; and c) if the data element comprises display layout control information (e.g. a style sheet) defining how another data element (such as the text of the email) should be displayed on a display screen, the tag would identify the data element as a style sheet.

Streaming media communications between the web server application 230 (such as multicast streaming media messages provided by the IP multicast module 231) and the client application 115 utilize a sequence of RTP frames that include compressed media data and are sent utilizing UDP/IP channels.

To provide communication services to each subscriber, the web server application 230 processes certain scripts in response to events generated by a subscriber station 24 and the packet audio/video gateway 232. In processing the scripts, the web server application 230 manages subscriber communication data stored in the storage 235 and provides operating instructions to subscriber station 24 and the email module 228.

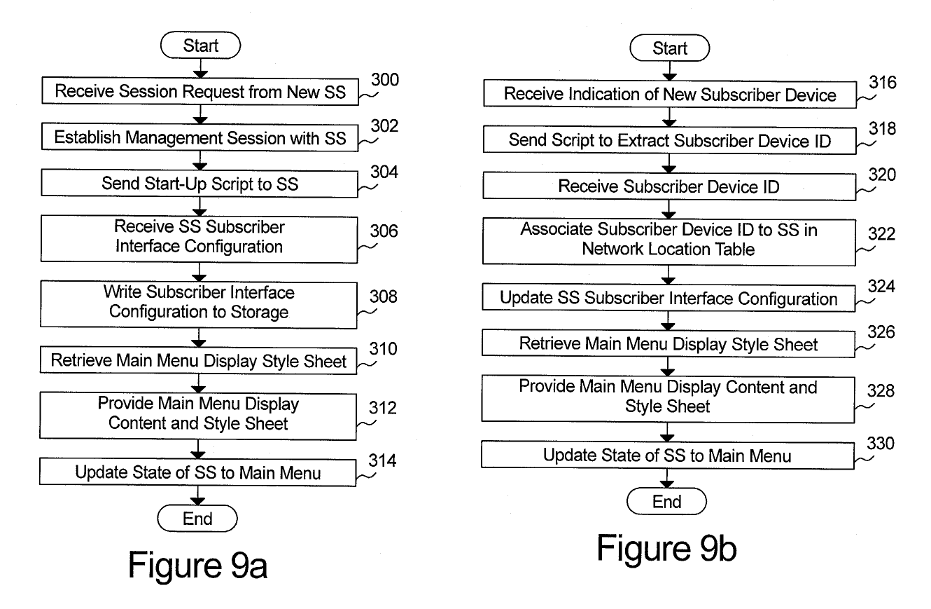

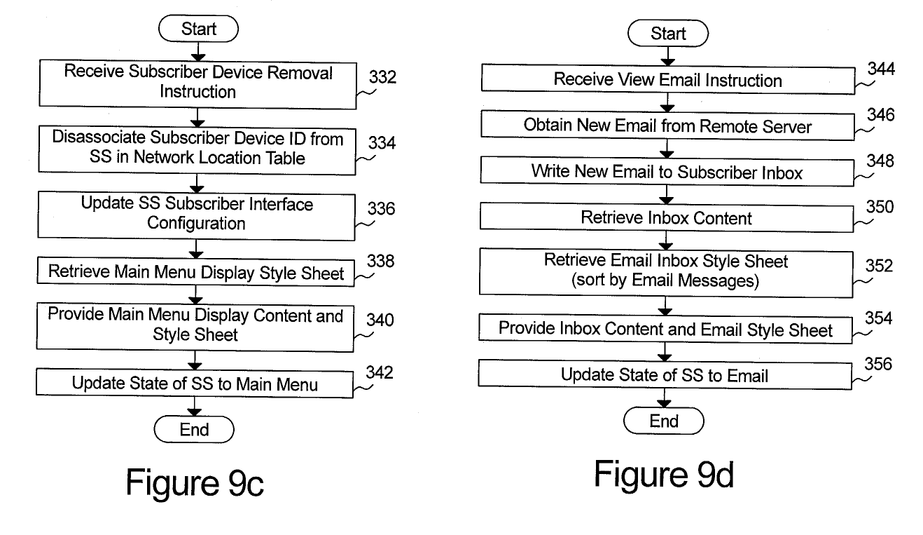

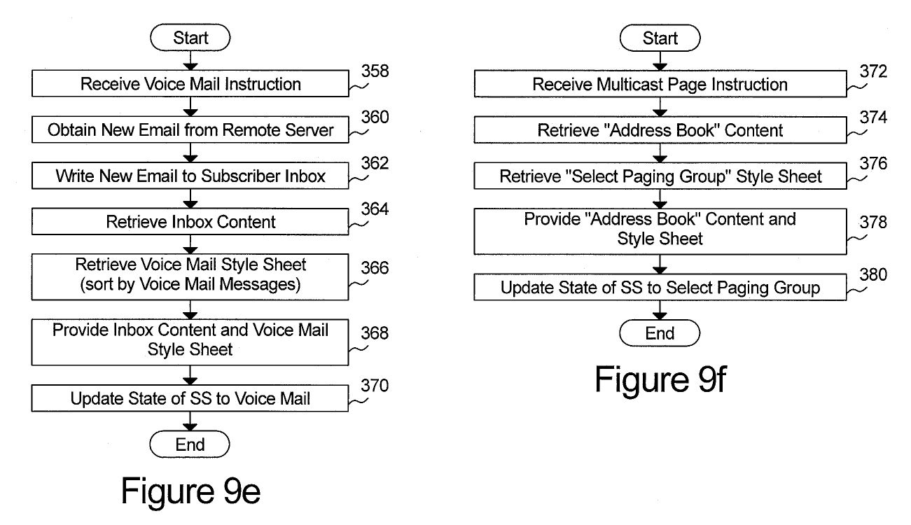

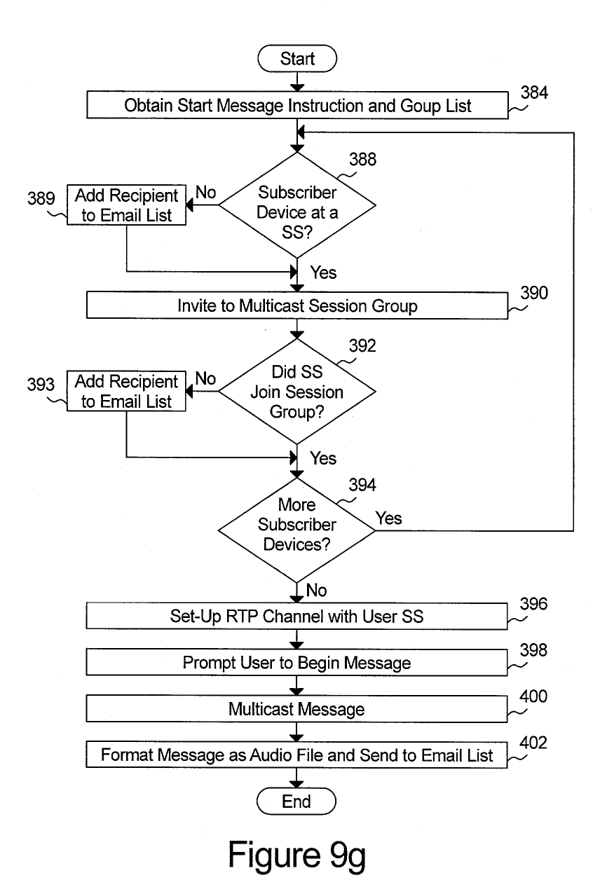

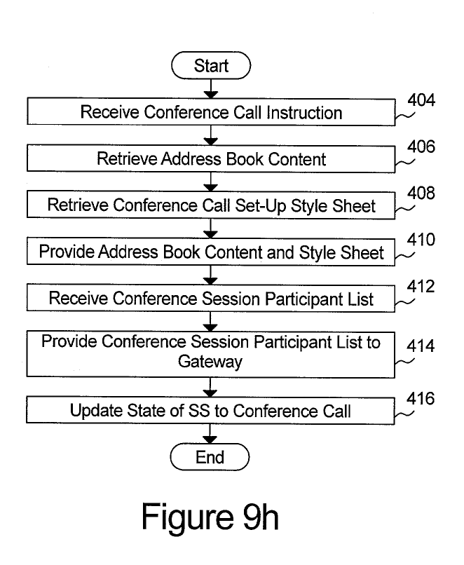

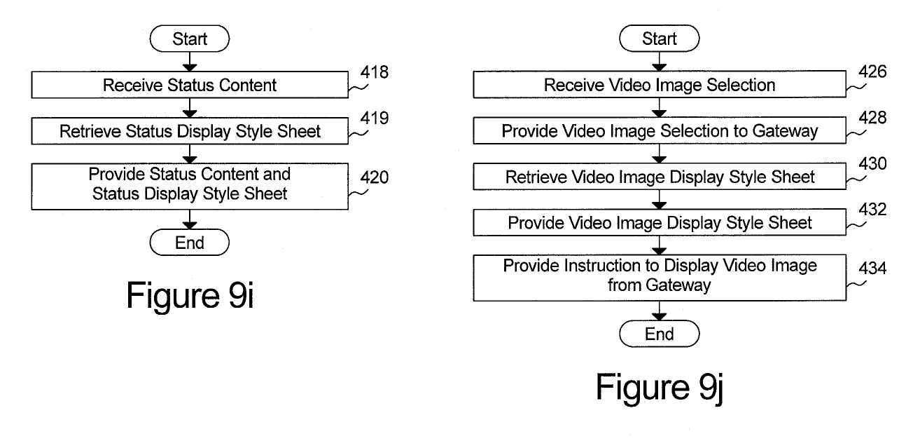

The flow charts of FIGS. 9a through 9g (which will be discussed in more detail herein) represent processing scripts that in aggregate provide for a subscriber to navigate through a layered menu to select applicable services form the control unit 12. The web server application 230 maintains state information for each subscriber station 24 such that each subscriber station 24 may navigate through the layered menu independently of other subscriber stations 24.

RTP Stream Routing

As discussed with respect to FIG. 1, several VOIP sessions established between subscriber stations 24 and endpoints coupled to the Internet 30 (and several active data connection sessions open by the web server 230) may congest the control unit's 12 connection to the ISP network 18 causing a quality of service failure or causing data frames (discussed later) to be delayed or lost to buffer overflow. Additionally, the ISP network 18 (or even portions of the Internet 30) may be congested causing such problems. As such, a RTP stream routing circuit 33 may couple to the communication module 16 and the PSTN interface 21 to establish supplemental connections with remote endpoints (or control units or proxys for remote endpoints) over the PSTN 42 (or a combination of a PSTN 42 connection to a dial up Internet service provider and a Internet connection with such remote endpoint, control unit, or proxy) and may route RTP frames over such supplemental connections. Such supplemental connections may be established when a quality of service failure occurs or if frames begin to overflow a frame buffer.

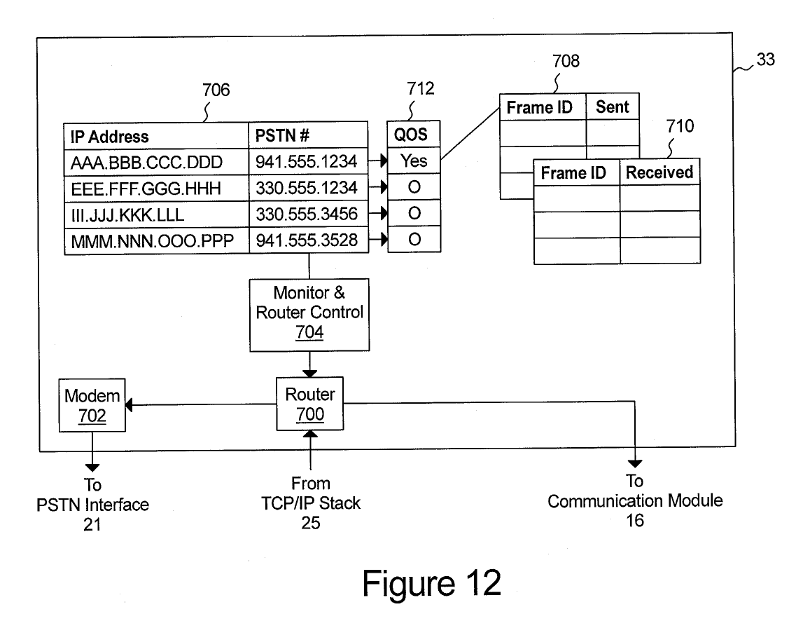

Referring briefly to FIG. 12, the RTP stream routing circuit 33 may include a router 700, a load monitor and router control circuit 704, and a modem 702. The modem functions to establish and maintain an IP connection with each of a plurality of remote devices over the PSTN 42. The router 700 routes UPD/IP frames representing a real time streaming media session to the remote endpoint utilizing either the communication module 16 or the modem 702 in accordance with the monitor and router control circuit 704.

The monitor and router control circuit 704 accesses a directory table 706 that associates the IP address of other known control unit's 12 (or other VOIP proxy devices) with a PSTN telephone number that can be used to establish a supplemental connection to such device. Further, the monitor and router control circuit 704 maintains an indication of quality of service 712 with such device at the IP address. For example, for each remote device to which a stream of RTP frames are being sent, the monitor and router control circuit 704 may maintain a table 708 that stores an ID of each frame sent and the time sent. As such, when the remote device returns a table 710 that includes the frame ID and time received, the monitor and router control circuit 704 can calculate delay and packet loss as a measure of quality of service. This measure may be included in the indication of quality of service 712.

To enable the remote device to have a similar function, the monitor and router control circuit 700 may log frames received and return a table similar to table 710 to each remote device with which a stream of RTP frames is received. It should be appreciated that the directory table 706 may be maintained locally in the control unit 12 or may be a global directory accessible on the Internet 30.

When a failure of quality of service occurs (or the web server application 230 of FIG. 2 indicates a significant delay or failure of data frames), the monitor and router control circuit 704 will obtain the PSTN telephone number associated with a IP address with which the quality of service failure has occurred and provide such telephone number to the modem 702 so that the modem 702 may establish a supplementary connection to such IP address. After a supplementary connection has been established, the monitor and control circuit 704 instructs the router 700 to route frames addressed to such IP address to the modem instead of to the communication module 16 thereby relieving the communication module 16 of the task or routing such frames on the ISP network 18.

The monitor and router control circuit 704 also monitors a frame buffer in router 700. Each frame for transmission, whether an RTP frame provided by the packet voice gateway 232 or a non-realtime data frame provided by the web server 230 will be queued for transmission in the frame buffer. The real time frames may be given priority for tranmission. In the event that the buffer begins to overflow, the higher priority RTP frames will likely still be transmitted while the non-realtime frames would likely be dropped. To reduce such problems, when the monitor and router control circuit 704 detects the buffer filling beyond a predetermined capacity, it may access the directory table 706 to select a PSTN telephone number of remote control unit (or VOIP proxy) to which one or more RTP streams are being sent, and enable the modem 702 to open a establish a supplemental connection to such remote control unit or VOIP proxy. As discussed above, once opened the router 700 may send frames addressed to such remote control unit or proxy using the supplemental connection. Such frame will then be queued in a separate frame buffer dedicated to the supplemental connection and will not utilize space in the frame buffer associated with the communication module 16.

The monitor and router circuit 704 also monitors the PSTN interface 21 for supplemental connections that may be initiated to the control unit 12 by a remote control unit or VOIP proxy and, if such a supplemental connection is detected, instructs the router 700 to route frames addressed to the IP address associated with the supplemental connection to the modem instead of to the communication module 16.

Because the IP address of the control unit 12 may change periodically, the monitor and router circuit 704 may periodically provide the IP address of the control unit 12 to a directory table available on the Internet to other control units and proxys.

Subscriber Station

Referring to FIG. 4, a perspective view of an exemplary subscriber station 24 is shown. The subscriber station 24 includes a platform unit 52 that operatively couples to the control unit 12 via either a wireless communication link between a platform unit network circuit 96 and the wireless network 22 or a direct network connection 23 between the platform unit 52 and the backbone network of the wireless network 22.

A plurality of functional modules 54, 56, 58, 60, and 11 may be coupled to the platform unit 52 to form an integrated multi-media communication platform. The platform unit 52 includes a subscriber interface docking platform 64 for coupling and optionally supporting one of a plurality of modular subscriber interface units 60 to the platform unit 52. The modular subscriber interface unit 60a may include a plurality of buttons 68 in an arrangement similar to a typical telephone key pad to provide for subscriber input in a manner similar to that of a traditional telephone handset. The modular subscriber interface 60b may include a touch panel graphic display 72 to provide for subscriber input through virtual buttons visible thereon.

The platform unit 52 further includes a first function specific docking platform 74a and a second function specific docking platform 74b, each of which couples to respective function specific modules 54 and 56. The first function specific docking platform 74a is a shallow platform for coupling to function specific modules that primarily comprise function specific buttons or other circuits that may be placed within a thin module. The second function specific docking platform 74b is a larger platform for coupling to function specific modules with more complex internal circuits requiring the additional size.

In the exemplary embodiment, the function specific module 54 may include subscriber interface buttons configured for enhancing voice communication through the subscriber station 24 such as a voice message control 76 for single button access to voice message files and voice management controls 86 for single button control of enhanced voice management functions.

The function specific module 56 may include circuits configured for enhancing data communication through the subscriber station 24 such as an email control 78 for single button access to subscriber email messages, a print control 80 for single button initiation of the printing of an email message, and a data networking port 84.

The platform unit 52 further includes a docking bay 62 into which a modular docking interface 58 may be secured and operatively coupled to the platform unit 52. The modular docking interface 58 supports one of a plurality of modular subscriber devices 50 within a subscriber device interface bay 66 and provides for operatively coupling the modular subscriber device 50 to the platform unit 52. Exemplary configurations for the modular subscriber device 50 include a subscriber data assistant 86, a subscriber wide area network communication device 88, and the wireless LAN voice handset 26, each of which is discussed in more detail herein.

While operatively coupled to the platform unit 52, the subscriber device 50 becomes an integral part of the subscriber interface of the subscriber station 24. A liquid crystal graphic display 90 on the subscriber device 50 may function to display multi-media communication management information under control of the platform unit 52 and the control unit 12. Further, programmable subscriber controls 92 positioned adjacent to the subscriber device 50 may be configured to activate platform unit 52 and control unit 12 functions in accordance with the contents of the graphic display 90 adjacent to the controls 92.

The platform unit 52 also includes docking bay 61 into which a modular video camera 11 may be coupled to the subscriber station 24. The modular video camera 11 provides a video image for use by the subscriber station 24 when participating in a video conference call.

The platform unit 52 may further include one or more of the following elements:

a) a handset 98 similar to a traditional telephone handset to provide a subscriber voice interface, b) a speaker 100 and a microphone 102 to provide a hands-free subscriber voice interface, c) a modular battery pack 70 (which fits within a battery pack bay that is not shown) for operating power when the subscriber station 24 is uncoupled from a line voltage, d) cell button 104 for single button selection of certain functions such as a wide area network communication function, e) help button 106 for single button selection of a help function, and f) a secure button 108, selection of which actuates encryption of the VOIP session supporting a subscriber's call from the subscriber station 24.

FIG. 5 shows a block diagram of the subscriber station 24. The platform unit 52 includes an application controller 112 coupled to a local bus 116 that interconnects the controller 112 with a plurality of peripheral circuits that include a wireless module 94, a power management controller 120, a communication controller 122, a network switch controller 124, a key switch controller 126, a touch panel controller 128, and a voice communication system 130.

The wireless module 94 operatively couples the platform unit 52 with the control unit 12 over the wireless LAN 22 (both of FIG. 2). The controller 112 includes appropriate drivers for operation of the wireless module 94.

The power management controller 120 selectively receives input power from the battery pack 70 or external line voltage 134. The power management controller 120 includes appropriate circuits for converting the input power voltage to appropriate operating power required by each component of the subscriber station 24. Additionally, the power management controller 120 includes appropriate circuits for managing charging of the battery pack 70 when the platform unit 52 is coupled to the line voltage 134 and generating appropriate power for operating and/or charging the modular docking interface 58 and the modular subscriber device 50 when coupled to the platform unit 52.

The communication controller 122 operatively couples the modular docking interface 58 and the modular subscriber device 50 to the controller 112 such that the platform 52 can exchange data with the modular subscriber device 50. In the exemplary embodiment, the communication controller 122 is a serial communication controller that enables the serial exchange of data with a compatible serial communication controller within the modular subscriber device 50 over a physical medium. Exemplary physical mediums include hardwired contacts, an infrared transmission, and RF transmission, however other physical mediums are envisioned and which medium is used is not critical to this invention.

The communication control 122 also operatively couples the modular video camera 11 to the controller 112 such that the platform unit 52 may power the video camera 11 and receive the video image from the video camera 11.

The network switch controller 124 provides a network data port 84 which enables the controller 112 to communicate with another network computing circuit over a network interface. The network switch controller 124 is coupled to a bus port 135 within the function specific docking platform 74b for coupling to a mating port 148 on the function specific module 56.

The key switch (e.g. button) controller 126 is coupled to: 1) a connector 136a which in turn is coupled to a mating connector on the modular subscriber interface unit 60a (FIG. 4) for interconnecting the buttons 68 to the key switch controller 126; 2) a connector 136b which in turn is coupled to a mating connector 142 on the function specific module 54 for interconnecting the buttons 76 and 86 to the key switch controller 126; 3) the bus port 135 which in turn is coupled to a mating port 148 on the function specific module 56 for interconnecting the buttons 78 and 80 to the key switch controller 126; 4) the cell button 104; 5) the help button 106; and 6) the secure button 108. In the exemplary embodiment, the key switch controller 126 may drive row and column signals to the various buttons and, upon detecting a short between a row and a column (e.g. button activation) reports the button activation to the application controller 112 over the bus 116. Again, the application controller 112 includes appropriate drivers for operating the key switch controller 126.

The touch panel controller 128 is coupled to a connector 144 which in turn is coupled to a mating connector on the modular subscriber interface unit 60b (FIG. 4) for interconnecting the touch panel graphic display 72 to the touch panel controller 128. In the exemplary embodiment, the touch panel controller 128 may include a separate display control circuit compatible with the resolution and color depth of the touch panel graphic display 72 and a separate touch panel control circuit for detecting subscriber contact with the touch panel graphic display 72. The application controller 112 includes appropriate systems for driving the contents of the touch panel graphic display 72 through the touch panel controller 128.

The voice communication system 130 generates analog voice signals for driving the speaker 100 (or the speaker in the handset 98 of FIG. 4) and detects input from the microphone 102 (or the microphone in the handset 98) under the control of the application controller 112.

In the exemplary embodiment, the controller 112 executes a packet audio/video communication client 113 and a client application 115. The packet audio/video communication client 113 includes a session set up circuit 118 and a compression/encryption circuit 114.

The session set up circuit 118 provides for establishing communication session with remote endpoints over the network 22 and over the wide are network service provider network 27 when a wide are network communication device 88 is coupled to the platform unit 52.

More specifically, with respect to communication sessions over the network 22, the session set up circuit 118 provides for sending (and responding to) applicable session signaling messages to (and from) another endpoint (whether on network 22 or the Internet 30) to establish a VOIP session with such other endpoint. The session set up circuit 118 also provides for sending (and responding to) applicable session signaling messages to (and from) the gateway 232 over the network 22 to initiate a conference session to conference session participants.

With respect to communication sessions over the wide area network 27, the session set up circuit 118 provides for sending signals to the wide area network communication device 88 via the communication controller 122 to provide for the wide are network communication device 88 to establish a wireless communication session over the wide are network 27. Such wireless communication session can be established either by answering an incoming wireless call or by placing an outgoing wireless call. The session set up circuit 118 will provide signals to the wide area network communication device 88 for answering an incoming call in response to the subscriber activating the cell button 104 while the wide area network communication device 88 is ringing. The session set up circuit 118 will provide signals to the wide area network communication device 88 for placing an outgoing call through the wide area network communication device 88 in response to subscriber entry of a telephone number (by selecting from an address book or by key entry or virtual key entry on the touch panel 72) and subscriber activation of the cell button 104 to indicate subscriber desire to place the outgoing call through the wide area network communication device 88 instead of through the network 22.

Additionally, the session set up circuit 118 may provide signals to place an outgoing call through the wide are network communication device 88 even if the operator does not activate the cell button 104, but the subscriber station 24 receives an indication from the control unit 12 that the network 22, the ISP network 18, or the trunk lines to the PSTN 42 are too congested to complete the real time streaming media session and a wide are network communication device 88 is docked to the platform unit 52 and capable of completing the session.

The compression/encryption circuit 114 exchanges the sequences of RTP frames representing compressed audio data and video data with the other endpoint and translates between compressed (and optionally encrypted) RTP frames and digital audio and digital video data. More specifically, the compression/encryption circuit 114 compresses video images from the video camera 11 into a sequence of RTP frames for sending to the other endpoint, compresses voice signals from the voice communication circuit 130 into sequences of RTP frames for sending to the other endpoint, and decompresses RTP frames of video images and audio signals received from the other endpoint for driving the voice communication circuit 130 and for displaying a video image on a display. In the exemplary embodiment, the packet audio/video communication client 113 may be one of the commercially available clients utilizing established protocols such as the International Telephone Union (ITU) H.323 protocols, The Internet Engineering Task Force (IETF) Session Initiation Protocols, or other protocols useful for signaling and establishing a real time streaming media session with the packet audio/video gateway 232.

The session set up module 118 includes circuits for generating and sending applicable messages to the other endpoint to initiate encryption of a VOIP session in response to operator activation of the secure button 108. The applicable messages will include negotiation of an encryption algorithm and the exchange of each endpoint's public encryption key. Further, in response to successful initiation of encryption during a VOIP session that is not a conference session, the session set up module 118 may generate an applicable signal to illuminate the secure button 108. Further, in response to an all-secure message from the conference module 237 during a conference session, the module may generate the applicable signal to illuminate the secure button 108.

The client application 115 operates as a client to the web server application 230 (FIG. 4) within the control unit 12. The client application 115 provides for the controller 112 to: a) generate an image on the touch panel graphic display 72 or on the graphic display 90 on the subscriber device 50 in accordance with display content and a style sheet received from the control unit 12; b) output an audio stream file received from the control unit 12 through the dialog system 130; c) execute processing steps in accordance with instructions received from the control unit 12; d) provide messages indicating subscriber actions (such as subscriber activation of the cell button 104, the help button 106, a touch panel virtual button, or any other button on the subscriber station 24) to the web server application 230; e) activate the packet audio/video client 113 to set up a real time audio/video session with the packet audio/video gateway 232 (FIG. 3); f) identify the modular configuration or subscriber interface configuration of the subscriber station 24 and report the configuration to the control unit 12; and g) report the coupling of (and decoupling of) a subscriber device 50 and/or modules to the platform 52 of the subscriber station 24 to the control unit 12.

Subscriber Data Assistant

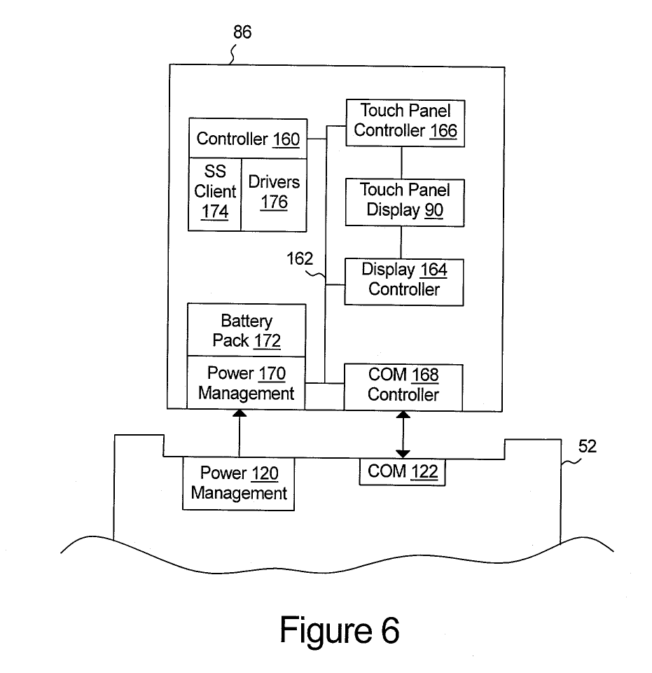

Turning to FIG. 6, exemplary structure of a subscriber data assistant 86 is shown. The subscriber data assistant 86 includes a controller 160 interconnected to a plurality of peripheral controllers by an internal bus 162. Because of the small size and the portability of the subscriber data assistant 86, the touch panel 90 provides the primary subscriber interface. The touch panel 90 is controlled by a display controller 164 and a touch panel controller 166. The display controller 164 drives the liquid crystal display of touch panel 90 using signals compatible with the resolution and color depth of the display 90. The touch panel controller 166 detects user activation of the touch panel 90. The controller 160 operates appropriate drivers 176 for controlling operation of the touch panel controller 166 and the display controller 164.

A communication controller 168 is also coupled to the bus 162 and operates under control of the application controller 160. In the exemplary embodiment, the communication controller 168 is a serial communication controller that is compatible with the communication controller 122 of the platform unit 52 (both of FIG. 5) such that data communication may occur between the platform unit 52 and the subscriber data assistant 86 when the subscriber data assistant 86 is operatively coupled to the platform unit 52.

A power management circuit 170 selectively receives input power from a battery pack 172 or from the power management circuit 120 in the platform unit 52. The power management circuit 170 includes appropriate circuits for converting the input power voltage to appropriate operating power required by each component of the subscriber data assistant 86. Additionally, the power management circuit 170 includes appropriate circuits for managing charging of the battery pack 172 when the subscriber data assistant is coupled to the platform unit 52.

The controller 160 also operates subscriber station client application 174 for displaying multi-media communication management information under control the platform unit 52 when coupled to the platform unit 52. In the exemplary embodiment the subscriber station client application 174 receives messages from the platform unit 52 in the form of tagged messages. After receipt of the tagged messages, the subscriber station client application 174 builds a display document to display the communication management information represented by tagged content messages in accordance with a style sheet that is compatible with the size, resolution, and color depth of the touch panel display 90. The display document is then displayed on the touch panel display 90.

It should be appreciated that in additional to operating the drivers 176 and the subscriber station client application 174, the controller 160 may optionally operate any of the software applications that are commercially available for personal data assistants (PDAs) which may include address book management, calendar management, and games. While operation of such PDA applications may be useful to the subscriber, it is not critical to the operation of the present invention.

Subscriber Wide Area Network Communication Device

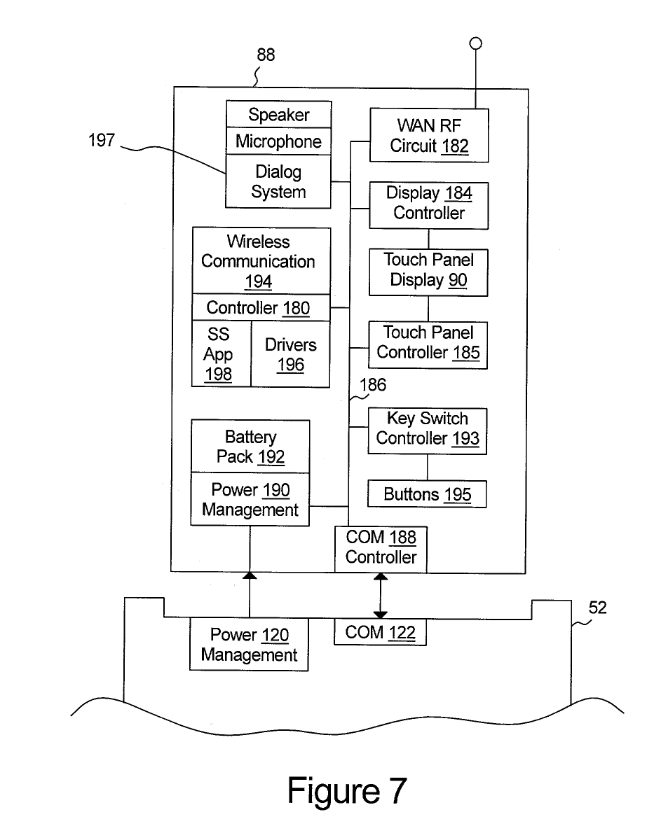

Turning to FIG. 7, exemplary structure of a subscriber wide area network communication device 88 is shown. The wide area network communication device 88 includes a controller 180 operating a subscriber station application 198, a wireless communication application 194, and applicable drivers 196 for a plurality of peripheral controllers. The controller 180 is interconnected to the plurality of peripheral controllers by an internal bus 186. The peripheral controllers include a wide area network RF circuit 182, a voice system 197, a display controller 184, a touch panel controller 185, a key switch controller 193, a communication controller 188, and a power management system 190.

The wide area network RF circuit 182 may be a circuit for transmitting and receiving signals from a wide area network service provider's network 27 under control of the wireless communication application 194.

The key switch controller 193 is coupled to the control buttons 195. The key switch controller 193 drives row and column signals to the control buttons 195 and, upon detecting a short between a row and a column indicating button activation, reports the activation to the controller 180. The control buttons may be used by a subscriber for operating the wide area network communication device 88 when uncoupled form the platform unit 52.

The voice system 197 includes a speaker and a microphone. Under control of the wireless communication application 194, the voice system 197 may provide a subscriber voice interface for an audio session with a remote device over the wide area network service provider's network 27.

The display controller 184 drives the display 90 using signals compatible with the resolution and color depth of the display 90. The display 90 may optionally be a touch panel display 90 and the touch panel controller 185 detects user activation of the touch panel 90.

The communication controller 188 may be a serial communication controller compatible with the communication controller 122 in the platform unit 52 such that data communication may occur between the platform unit 52 and the wide area network communication device 88 when the wide area network communication device 88 is operatively coupled to the platform unit 52.

The power management controller 190 operates with a battery pack 192, both of which may operate in a similar manner to the power management controller 170, and the battery pack 172 discussed with reference to FIG. 6.

Similar to the subscriber data assistant 86 (FIG. 6), when the wide area network communication device 88 is coupled to the platform unit 52, the subscriber station application 198 provides for displaying multi-media communication management information under control of the platform unit 52 and provides for multi-media communication directly between the platform unit 52 and the wide area network service provider medium.

In addition subscriber station application 198 may receive messages from the platform unit 52 which may be real time streaming audio for communication over the wide area network service provider network 27 during a real time streaming media session

When the message is for communication with the wide area network service provider medium, the subscriber station application 198 will reformat the message to a format compatible with wide area network service provider medium transmission standards and transmit the message using the wide area network RF circuit 182.

The wide area network communication device 88 may also receive signals from the wide area network service provider medium via the wide area network RF circuit 182. When received, the subscriber station application 198 reformats the messages into a plurality of tagged messages for communication to the platform unit 52 and sends the tagged messages to the platform unit 52 via the communication controller 188.

Web Server Application

Referring to FIGS. 9a through 9j in conjunction with FIG. 3, exemplary processing steps performed by the web server application 230 to provide communication services to a subscriber station 24 are shown.

The flowchart of FIG. 9a represents steps performed by the web server application 230 upon receiving an open session request on a predetermined port from a subscriber station 24 that has just been operatively coupled to the network 22, obtained a network address from the network address server 220, and is ready to operate as a client to the web server application 230. Step 300 represents receipt of the open session request and step 302 represents establishing a TCP/IP session with the subscriber station 24.

Step 304 represents sending a start up script to the subscriber station 24. The start up script includes instructions that, when executed by the client application 115, provide for the subscriber station 24 to detect its subscriber interface configuration (e.g. whether the subscriber station 24 includes a display screen and what capabilities such as video capabilities and graphic resolution capabilities the display screen may have) and to report its subscriber interface configuration back to the web server application 230.

Step 306 represents receipt of the subscriber interface configuration of the subscriber station 24 from the subscriber station 24 and step 308 represents writing an indication of the subscriber interface configuration of the subscriber station 24 to a subscriber interface table 239 in the storage 235.

Step 310 represents retrieving a main menu display style sheet from a selection of style sheets 241 stored in the storage 235. The retrieved main menu display style sheet will be a style sheet that corresponds to the subscriber interface configuration of the subscriber station 24.

Step 312 represents providing main menu display content and the style sheet to the subscriber station 24 and step 314 represents updating a subscriber station state table 243 in the storage 235 to indicate that the subscriber station 24 is in a main menu state.

It should be appreciated that the main menu content provided to the subscriber station 24 is independent of the subscriber interface, however, the style sheet provided to the subscriber station 24 is dependent on the subscriber interface. For example, turning to FIG. 10a which represents display of a main menu on a subscriber device 50 in the modular docking interface 58 the content of the main menu display includes a title of main menu and choices of view email, voice mail, and multi cast paging. The style sheet corresponding to a subscriber interface that includes a subscriber device 50 provides for the content to be graphically displayed with the title at the top and each menu choice to be displayed adjacent a button 92 on the modular docking interface 58. Alternatively, turning to FIG. 20b which represents display of a main menu on a display 72 that is coupled to a subscriber station interface 64 (FIG. 4), the content of the main menu display again includes a title of main menu and the choices of view email, voice mail, and multi cast paging. However, the style sheet that corresponds to a subscriber interface that includes a display 72 that is coupled to a subscriber station interface 64 provides for the content to be graphically displayed with the title at the top and each choice to be displayed in a vertical list with an adjacent numeral for selection using the keypad 68 (FIG. 4). The examples shown in FIGS. 10a and 10b are for illustrative purposes only. Other subscriber interface configurations that include non-graphic displays, bit mapped multi line text displays, or 7 element single or multi line text displays may utilize different style sheets for displaying all or a portion of the main menu content.

The flowchart of FIG. 9b represents steps performed by the web server application 230 upon receiving an indication that a subscriber device 50 has been coupled to a subscriber station 24. Step 316 represents receipt of such indication.

Step 318 represents sending a device ID extraction script to the subscriber station 24. The device ID extraction script includes instructions that, when executed by the client application 115, provide for the subscriber station 24 to interrogate the subscriber device 50 to determine its device identification (e.g. an identification of which subscriber to which the device has been assigned) and to report the device identification back to the web server application 230.

Step 320 represents receipt of the device identification back from the subscriber station 24 and step 322 represents associating the device ID with the subscriber station 24 in the network location table 245 in the storage 235. As discussed previously, the packet audio/video gateway 232 utilizes the network location table 245 for routing incoming telephone calls to the particular subscriber station 24 at which a subscriber's subscriber device 50 is then currently coupled. It should be appreciated that this step 322 provides for the network location table 245 to properly indicate association between a subscriber station 24 and the subscriber device 50 that is served thereby.

Because the style sheet selected for display of content on the subscriber station 24 is dependent on the subscriber interface configuration of the subscriber station 24 as determined by the subscriber interface table 239, the table should be updated when the subscriber interface configuration changes. Coupling a subscriber device 50 to a subscriber station 24 changes the subscriber interface because the display of the subscriber device 50 becomes a display for the subscriber station 24. As such, step 324 represents updating the subscriber interface configuration of the subscriber station 24 in the subscriber interface table 239.

Step 326 represents retrieving a main menu display style sheet that is applicable to the new subscriber interface configuration from the selection of style sheets 241 in the storage 235 and step 328 represents providing main menu display contend and the style sheet to the subscriber station 24. Step 330 represents updating the subscriber station state table 243 to assure that it represents that the subscriber station 24 is in the main menu state.

The flow chart of FIG. 9c represents steps performed by the web server application 230 upon receiving an indication that a subscriber device 50 has been removed from a subscriber station 24. Step 322 represents receipt of such an indication.

Because the packet audio/video gateway 232 utilizes the network location table 245 for routing incoming telephone calls to the particular subscriber station 24 at which a subscriber's subscriber device 50 is then currently coupled, the network location table should be updated upon removal of a subscriber device form a subscriber station 24. Step 334 represents disassociating the subscriber device 50 from the subscriber station 24 in the network location table 245.

Because the display on the subscriber device 50 is no longer part of the subscriber interface of the subscriber station 24 after the subscriber device 50 is removed, step 336 represents updating the subscriber interface configuration table 239.

Step 338 represents retrieving a main menu display style sheet that is applicable to the subscriber interface configuration without the subscriber device 50 from the selection of style sheets 241 in the storage 235 and step 340 represents providing main menu display content and the style sheet to the subscriber station 24. Step 342 represents updating the subscriber station state table 243 to assure that it represents that the subscriber station 24 is in the main menu state.

The flowchart of FIG. 9d represents steps performed by the web server application 230 upon receiving a subscriber indication of a command to view subscriber email messages. The means by which the subscriber station 24 may detect such a subscriber indication is dependent on the subscriber interface configuration of the subscriber station 24. For example, if the subscriber interface includes the email button 78 (FIG. 4), detection of button 78 activation would be a subscriber indication of a command to view subscriber email messages. Similarly, subscriber activation of the email menu choice on the main menu either by touch panel activation or by activation of a button associated with the menu choice (either or both of which may be applicable dependent on the subscriber interface configuration) would be a subscriber indication of a command to view subscriber email messages. Step 344 represents the web server application 230 receiving the subscriber indication of a command to view subscriber email messages.

Step 346 represents instructing the email module 228 to logon to an email server (which may be a remote email server coupled to the network 18) and to receive new email messages associated with the subscriber's account. Step 348 represents writing the new email messages to the subscriber inbox in the email files 247 in the storage 235. In an embodiment wherein the remote email server maintains subscriber inbox information, steps 346 and 348 may be viewed as synchronizing the email messages between the remote server and the email files 247. It should also be appreciated that the email module 228 may periodically retrieve new email messages and write to the subscriber inbox independently of whether the subscriber has activated an email control. As such, the inbox will already include new messages and steps 346 and 348 may not need to be performed in response to event 344.

Step 350 represents retrieving inbox content from the email files 247 and step 352 represents retrieving an inbox style sheet that is applicable to the subscriber interface from the style sheets 241 in the storage 235. Because the subscriber's voice mails will be sent to the subscriber's email account as audio files, it is possible that the email messages retrieved at step 346 will include both text based emails and emails from the voice mail server 236. Because the subscriber activated a command to view email messages, the inbox style sheet provides for the display of the email messages received from senders other than the voice mail server 236 to be displayed first (or on the top of the display).

Step 354 represents providing the inbox content and style sheet to the subscriber station 24 and step 356 represents updating the subscriber station state table 243 to indicate that the subscriber station 24 is in an email state.

The flowchart of FIG. 9e represents steps performed by the web server application 230 in response to receiving a subscriber indication of a command to obtain voice mail messages. Again, the means by which the subscriber station 24 may detect such a subscriber indication is dependent on the subscriber interface configuration of the subscriber station 24. For example, if the subscriber interface includes the voice mail button 76 (FIG. 4), detection of button 76 activation would be a subscriber indication of a command to obtain voice mail messages. Similarly, subscriber activation of the voice mail menu choice either by touch panel activation or by activation of a button associated with the menu choice would be a subscriber indication of a command to obtain voice mail messages. Step 358 represents the web server application 230 receiving the subscriber indication of a command obtain voice mail messages. Because voice mail messages will be sent as audio files form the voice mail server 236 to the subscriber's email account, step 360 represents instructing the email module 228 to logon to the email server and to receive new email messages associated with the subscribers account. Step 362 represents writing the new email messages to the subscriber inbox in the email files 247 in the storage 235.

Step 364 represents retrieving inbox content from the email files 247 and step 366 represents retrieving a voice mail style sheet that is applicable to the subscriber interface from the style sheets 241 in the storage 235. Because the email messages that include voice mail audio files from the voice mail server 236 may be intermixed with email messages from other senders, the voice mail style sheet provides for only the display of the voice mail messages received from the voice mail server 236.

Step 368 represents providing the inbox content and the voice mail style sheet to the subscriber station 24 and step 370 represents updating the subscriber station state table 243 to indicate that the subscriber station 24 is in a voice mail state.

The flowchart of FIG. 9f represents steps performed by the web server application 230 upon receiving a subscriber indication of a command to initiate a multicast paging message. The subscriber station 24 may detect such a subscriber indication by various means, such as touch panel activation or button activation of a menu selection on the main menu, dependent on the subscriber interface configuration of the subscriber station 24. Step 372 represents the web server application 230 receiving the subscriber indication of a command to initiate a multicast paging message.

Step 374 represents retrieving the subscriber's address book content 249 from the email files 247. Turning briefly to FIG. 8b, the address book content 249 may comprise a plurality of records with each record including a group identification name and identification of each subscriber in such group, and, if the group identifies a single person, contact information for the person.

Step 376 represents retrieving a select paging group style sheet that corresponds to the subscriber interface of the subscriber station 24 and step 378 represents providing both the address book content and the select paging group style sheet to the subscriber station 24. Step 380 represents updating the subscriber station state table 243 to indicate that the subscriber station 24 is in the select paging group state.

FIG. 10c represents an exemplary display of the select paging group content utilizing a style sheet that may be applicable for use on a display 72 wherein the subscriber may use buttons or touch panel activation to select one or more paging groups to include in the multicast page. It should be appreciated that some paging groups may include only a single name such that individuals may be selected to include in the multicast page. Because the list of groups included in the paging group content may be larger than can be displayed on the display 72, the style sheet may provide for only a portion of the content to be displayed along with touch activated scroll controls for display of the remainder of the content. The style sheet may further include touch activated controls to return to the main menu and to start the multicast message.

FIG. 10d represents an exemplary display of the select paging group content utilizing a style sheet that may be applicable for display of the content on a display of a subscriber device 50 coupled in the modular docking interface 58. Because subscriber selection is to be by activation of buttons 92, the style sheet provides for the content to be displayed with the groups on the left side for selection by buttons 92 on the left side of the modular docking interface 58 and for indicators to label the function of the buttons 92 on the right side of the modular docking interface 58 such as scroll up, scroll down, start message, and return to main menu.

The flowchart of FIG. 9g represents steps performed by the web server application 230 upon receiving a subscriber indication of a command to start the multicast paging message. Step 384 represents receipt of such a subscriber indication along with identification of the subscriber selected multicast groups to include in a multicast recipient list.

Steps 388 through 394 represent steps that are performed by the web server application 230 for each recipient. Such steps may be performed in sequence or in parallel. For purposes of illustration, the steps are shown performed in sequence. Step 388 represents identifying the subscriber device 50 that is associated with the recipient and determining if the subscriber device is then currently coupled to a subscriber station 24. If yes, step 390 represents inviting such subscriber station 24 to the multicast session group. However, if the subscriber device 50 associated with the recipient is not coupled to a subscriber station 24 where the subscriber may receive the multicast, then at step 389 the recipient is added to an email list.

Following step 390, step 392 represents determining whether the subscriber station 24 joined the multicast session group. If the subscriber station 24 is operating a voice session, it would be inappropriate to interrupt the voice session with a multicast page for the subscriber. As such, it is envisioned that the subscriber station 24 may, when in certain operational states, not join the multicast session group. In which case, the recipient is added to the email list at step 393. At this time, the voice mail module 236 is invited to the multicast session group to receive the multicast on behalf of each recipient added to the email list at step 389 or 393.

After the recipient is either added to the email list at step 393 or the subscriber station 24 joined the multicast session group at step 392, step 394 represents determining if steps 388 though 392 must be performed for additional recipients. If not, step 396 represents establishing a RTP channel with the subscriber station 24 that initiated the multicast paging message and step 398 represents instructing the web server 230 to prompt the subscriber to begin the multicast paging message.

Step 400 represents multicasting the message to the session group utilizing the multicast module 231 and step 402 represents instructing the voice mail module 236 to, build an audio file and send the audio file by email to each recipient that was added to the email list at either step 389 or 393.

The flowchart of FIG. 9h represents steps performed by the web server 230 upon receiving a subscriber indication of a command to initiate an audio or an audio/video conference call from a subscriber station 24. The subscriber station 24 may detect such a subscriber indication by various means, such as by subscriber activation of the conference call control 502 on the touch panel 72 of FIG. 10b or by activation of a button 92 corresponding to the conference call menu selection on the display screen 50 of FIG. 20a. Step 404 represents the web server 230 receiving such an indication from a subscriber station 24.

Step 406 represents retrieving the subscriber's address book content 249 from the email files 247 and step 408 represents retrieving a “select conference session participants” style sheet that corresponds to the subscriber interface of the subscriber station 24 from the style sheets 241 in the storage 235. Step 410 represents providing both the address book content and the style sheet to the subscriber station 24 for display.

Step 412 represents receiving subscriber selection of participants for the conference call. FIG. 10e represents an exemplary display of the address book for selection of conference call participants on the touch panel 72. The subscriber station 24 may detect subscriber activation of the touch panel 72 to “highlight” conference call participants and indicate that selection is complete by activating a finished control 512. Upon activation of the finish control 512, the subscriber station 24 will provide the subscriber selection of participants to the web server 230.

Step 414 represents instructing the session set up module 118 to initiate a conference call by providing the session participant list to the packet audio/video gateway 232 as discussed above and step 416 represents updating the state of the subscriber station 24 to a conference call state.

After receiving the session participant list from the web server 230, the packet audio/video gateway 232, or more specifically the call signaling module 227 (FIG. 3) will establish applicable audio and video communication channels with those subscriber stations 24 that are serving subscriber devices associated with the participants in accordance with the steps discussed with respect to FIG. 11a. With the communication channels open, the packet voice gateway 232 will activate the conference mix module 237 to begin mixing the audio streams from each subscriber station 24 participating in the conference call and will report the status of each participant to the web server 230 as discussed above. More specifically, the status will include an indication of whether each session participant is connected to the conference or is inactive (not connected to the conference) and will include an indication of whether each session participant is on a secure VOIP session with the packet voice gateway 232. As will be discussed later, the status may also indicate whether the participant has stopped providing an active audio stream (e.g. put his or her phone on mute) and may indicate whether the conference mixing module 237 has suspended sending a conference mix to the participant (e.g. the packet audio/video gateway 232 has placed a particular participant on hold for a time period to so that others can converse without such participant hearing the conversation).

The flowchart of FIG. 9i represents steps performed by the web server application 230 upon receiving conference status content from the packet audio/video gateway 232. Step 418 represents receipt of the status content. Step 419 represents retrieving a “status” style sheet form the style sheets 241 in the storage 235 and step 420 represents providing the status content and the style sheet to at least the initiating subscriber station 24 and optionally, to other subscriber stations 24 participating in the conference call. It should be appreciated that the steps for the flowchart of FIG. 9i may be repeated several times during the duration of a conference call as the status of each participant changes.

FIG. 10f represents an exemplary display of the status of each participant on the touch panel 72. The display includes a vertical listing of each participant and an indication of the participants status in a column 514. An “A” indicates that the participant is active (e.g. sending a non-mute audio stream and receiving a conference mix audio stream). An “I” indicates that the participant is not on the conference call. A “M” indicates that the participant has muted his or her telephone and is not sending an audio stream. An “H” indicates that the participant has been placed on hold by the initiating subscriber station and is not receiving a conference mix.

The display also includes a video indication column 516. This column indicates which participants are not sending a video image signal to the packet voice/video gateway 232 (e.g. the “φ” symbol). Because the subscriber may select which of the participants to view during a video conference, the video column 516 will also indicate the subscribers selection of the video image to view if the subscriber activates the video control 520. In the exemplary display, the “*” symbol associated with Dave indicates that the subscriber would view the video image provided by Dave's subscriber station 24 upon activating the video control 520. The subscriber may change such selection by utilizing the controls of the touch panel 72. Upon detecting activation of the video control, the communicating subscriber station 24 will report the indication to the web server application 230.

The display also includes a hold control 522. The initiating subscriber may indicate his or her desire to place a participant(s) on hold status by highlighting the participant(s) and activating the hold control 522. Upon detecting activation of the hold control 522, the subscriber station 24 will report the indication to the web server application 230. Upon receiving the indication, the web server application 230 will provide the indication to the packet voice/video gateway 232 which will place the selected participant(s) on hold status and return updated status content to the web server application 230.

The display further includes a secure/encryption indication column 518. Symbols in the column 518 indicate whether communications between the associated participant are over a secure VOIP session. A “Y” indicates that such communications are secure while a “N” indicates that communications with the associated participant are not secure.

The flow chart of FIG. 9j represents steps performed by the web server 230 upon receiving a subscriber indication of a video image selection from a subscriber station 24. Step 426 represents such receipt by the web server 230. Step 428 represents providing the video image selection to the packet voice/video gateway 232. The packet voice/video gateway 232 will then begin relaying the selected video image to the subscriber station. Step 430 represents the web server application 230 retrieving a style sheet for the display of the video image. Step 432 represents providing the style sheet to the subscriber station 24 and step 434 represents providing instructions to display the video image received from the packet voice/video gateway 232 in conjunction with the style sheet.

FIG. 10g represents an exemplary display of a single video image on the touch panel 72. The display will include a control to return to the status page which, when activated, will cause the subscriber station 24 to return to the display of FIG. 10f. The display includes an indication 524 that the communication with the displayed person is secure.

The display will also include a scroll video control 530 which, when activated will cause the subscriber station 24 to report such activation to the web server 230. The web server 230 performs the steps discussed with respect to FIG. 9j with the selected image scrolled by one video image.

The display will also include a ¼ video control 528 which, when activated will cause the subscriber station 24 to report such activation to the web server application 230. The web server application 230 will perform the steps discussed with respect to FIG. 9j but the packet voice/video gateway 232 will provide a mixed video image comprising each of four video images arranged in the four corners of the display as represented by FIG. 10h.

From any of the displays associated with the conference call (e.g. FIG. 10e, FIG. 10f, FIG. 10g, and FIG. 10h, termination of the call will cause the subscriber station 24 to return to the main menu as represented by FIGS. 10a or 10b.

The systems and methods of the invention provide enhanced conference call services to subscribers of the multimedia communication management system of the invention. Although the invention has been shown and described with respect to certain preferred embodiments, equivalents and modifications will occur to others skilled in the art upon the reading and understanding of the specification. Those skilled in the art may envision other processing states, events, and processing steps to further the objectives of the modular multi-media communication management system of the invention. The invention includes all such equivalents and modifications, and is limited only by the scope of the following claims.

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. For example, modules for encryption, such as for storing public encryption keys, may be disposed in the subscriber's device 50, the subscriber station 24, or the control unit 12. Further, indicia that communications are secure may be provided by a module in the subscriber station 24 instead of by the mix module 238 of the controller 12.

1. A communication system controller that interconnects a plurality of communication stations with each of the Internet and the public switched telephone network, the communication system controller comprising:
means for receiving an indication of a remote endpoint from a communication station;
means for establishing a real time streaming media channel with the remote endpoint over the Internet;
means for sending frames including real time streaming audio to the remote endpoint utilizing the channel;
means for measuring whether a quality of service failure has occurred, a quality of service failure including at least one of frame loss and frame latency of frames sent on the channel falling below a quality of service threshold;
means for establishing a PSTN channel to the remote endpoint over the PSTN when a quality of service failure has occurred;
means for routing at least a portion of the frames sent to the remote endpoint over the PSTN channel.

2. The communication system controller of claim 1, wherein the means for measuring whether a quality of service failure has occurred includes:
means for storing an indication of when a frame was sent to the remote endpoint, receiving an indication of when a frame was received by the remote endpoint, and comparing the indication of when the frame was sent to an indication of when the frame was received to determine frame latency.

3. The communication system controller of claim 1, wherein the means for measuring whether a quality of service failure has occurred includes:
means for storing a sequence of frame identification indicators for each of a plurality of frames in a sequence sent to the remote endpoint, receiving a sequence of frame identification indicators for each of a plurality of frames received by the remote endpoint, and comparing the sequence of frame identification indicators for each of the frames sent to the remote endpoint with the sequence of frame identification indicators received by the remote endpoint to determine frame loss.

4. The communication system controller of claim 1, further including:
means for detecting that a remote endpoint has established a PSTN channel to the communication system controller.

5. A communication system controller that interconnects a plurality of communication stations with each of the Internet and the public switched telephone network, the communication system controller comprising:
a communication circuit for exchanging frames of data with a remote device over the Internet;
a modem interface circuit for establishing a PSTN connection with the remote device over the PSTN and for exchanging frames of data with the remote endpoint over the PSTN connection;
a monitor circuit comprising:
means for measuring whether a quality of service failure has occurred on the Internet, a quality of service failure including at least one of frame loss and frame latency of frames sent on the Internet falling below a quality of service threshold; and
means for identifying a remote device to the modem interface and providing an indication to the modem interface to establishing a connection with the remote device; and
means for instructing a router to route frames to the remote device over the PSTN connection.

6. The communication system controller of claim 5, wherein the means for measuring whether a quality of service failure has occurred includes:
means for storing an indication of when a frame was sent to the remote device over the Internet, receiving an indication of when a frame was received by the remote device, and comparing the indication of when the frame was sent to an indication of when the frame was received to determine frame latency.

7. The communication system controller of claim 6, wherein the means for measuring whether a quality of service failure has occurred includes:
means for storing a sequence of frame identification indicators for each of a plurality of frames in a sequence sent to the remote device over the Internet, receiving a sequence of frame identification indicators for each of a plurality of frames received by the remote device, and comparing the sequence of frame identification indicators for each of the frames sent to the remote endpoint with the sequence of frame identification indicators received by the remote device to determine frame loss.

8. The communication system controller of claim 5, further including:
means for detecting that a remote device has established a PSTN channel to the communication system controller.

9. A method of sending real time streaming media frames to a remote device, the method comprising:
receiving an indication of a remote endpoint from a communication station;
establishing a real time streaming media channel with the remote endpoint over the Internet;
sending frames including real time streaming audio to the remote endpoint utilizing the channel;
measuring whether a quality of service failure has occurred, a quality of service failure including at least one of frame loss and frame latency of frames sent on the channel falling below a quality of service threshold;
establishing a PSTN channel to the remote endpoint over the PSTN when a quality of service failure has occurred; and
routing at least a portion of the frames sent to the remote endpoint over the PSTN channel.

10. The method of sending real time streaming media frames to a remote device of claim 9, further comprising:
storing an indication of when a frame was sent to the remote endpoint, receiving an indication of when a frame was received by the remote endpoint, and comparing the indication of when the frame was sent to an indication of when the frame was received to determine frame latency.

11. The method of sending real time streaming media frames to a remote device of claim 10, wherein the means for measuring whether a quality of service failure has occurred includes:
means for storing a sequence of frame identification indicators for each of a plurality of frames in a sequence sent to the remote endpoint, receiving a sequence of frame identification indicators for each of a plurality of frames received by the remote endpoint, and comparing the sequence of frame identification indicators for each of the frames sent to the remote endpoint with the sequence of frame identification indicators received by the remote endpoint to determine frame loss.

12. The method of sending real time streaming media frames to a remote device of claim 9, further including:
means for detecting that a remote endpoint has established a PSTN channel to the communication system controller.

13. A communication system controller that interconnects a plurality of communication stations with each of the Internet and the public switched telephone network, the communication system controller comprising:
a communication circuit for exchanging frames of data with a remote device over the Internet;
a modem interface circuit for establishing a PSTN connection with the remote device over the PSTN and for exchanging frames of data with the remote endpoint over the PSTN connection;
a monitor circuit comprising:
means for measuring whether a quality of service failure has occurred on the Internet, a quality of service failure including at least one of frame loss and frame latency of frames sent on the Internet falling below a quality of service threshold; and
means for identifying a remote device to the modem interface and providing an indication to the modem interface to establishing a connection with the remote device; and
means for instructing a router to route frames to the remote device over the PSTN connection.

14. The method of sending real time streaming media frames to a remote device of claim 13, wherein the means for measuring whether a quality of service failure has occurred includes:
means for storing an indication of when a frame was sent to the remote device over the Internet, receiving an indication of when a frame was received by the remote device, and comparing the indication of when the frame was sent to an indication of when the frame was received to determine frame latency.

15. The method of sending real time streaming media frames to a remote device of claim 14, wherein the means for measuring whether a quality of service failure has occurred includes:
means for storing a sequence of frame identification indicators for each of a plurality of frames in a sequence sent to the remote device over the Internet, receiving a sequence of frame identification indicators for each of a plurality of frames received by the remote device, and comparing the sequence of frame identification indicators for each of the frames sent to the remote endpoint with the sequence of frame identification indicators received by the remote device to determine frame loss.

16. The method of sending real time streaming media frames to a remote device of claim 13, further including:
means for detecting that a remote device has established a PSTN channel to the communication system controller.

17. A communication system controller that interconnects a plurality of communication stations with each of the Internet and the public switched telephone network, the communication system controller comprising:
a local area network interface for receiving frames, including both real time streaming media frames and non-real time data frames, from a communication station;
a frame buffer for queuing the frames for transmission on the Internet;
means for establishing a supplemental PSTN channel to a remote endpoint over the PSTN when the frame buffer has filled above a predetermined capacity; and
a routing circuit for routing at least a portion of the real time streaming media frames to the remote endpoint on the supplemental PSTN channel.

18. The communication system controller of claim 17, wherein the frame buffer includes means for queuing real time streaming media frames with a higher priority for transmission than the non-real time data frames.

19. The communication system controller of claim 18, wherein the means for establishing a supplemental PSTN channel to a remote endpoint comprises:
means for selecting a remote endpoint to which real time streaming media frames are being sent;
means for determining a PSTN telephone number associated with the selected remote endpoint;
means for dialing the PSTN telephone number on the PSTN network; and
means for queuing real time media frames addressed to the selected remote endpoint in a second frame buffer associated with the selected remote endpoint for transmission on the supplemental PSTN channel.

20. The communication system controller of claim 18, further comprising:
means for receiving a PSTN telephone call from an initiating remote endpoint:
means for establishing a supplemental PSTN channel to with the initiating remote endpoint in response to receiving the PSTN telephone call from the initiating remote endpoint; and
means for routing at least a portion of the real time streaming media frames addressed to the initiating remote endpoint on the supplemental PSTN channel.

21. A method of sending real time streaming media frames to a remote device, the method comprising:
receiving frames, including both real time streaming media frames and non-real time data frames, from a communication station on a local network;
queuing the frames for transmission on the Internet;
establishing a supplemental PSTN channel to a remote endpoint over the PSTN when the frame buffer has filled above a predetermined capacity; and
routing at least a portion of the real time streaming media frames to the remote endpoint on the supplemental PSTN channel.

22. The method of claim 21, further comprising:
queuing real time streaming media frames with a higher priority for transmission than the non-real time data frames.

23. The method of claim 22, wherein the step of establishing a supplemental PSTN channel to a remote endpoint comprises:
selecting a remote endpoint to which real time streaming media frames are being sent;
determining a PSTN telephone number associated with the selected remote endpoint;
dialing the PSTN telephone number on the PSTN network; and
queuing real time media frames addressed to the selected remote endpoint in a second frame buffer associated with the selected remote endpoint for transmission on the supplemental PSTN channel.

24. The method of claim 22, further comprising:
receiving a PSTN telephone call from an initiating remote endpoint:
establishing a supplemental PSTN channel to with the initiating remote endpoint in response to receiving the PSTN telephone call from the initiating remote endpoint; and
routing at least a portion of the real time streaming media frames addressed to the initiating remote endpoint on the supplemental PSTN channel.
